(19) United States
(12) Patent Application Publication
(10) Pub. No.: US 2020/0085069 A1
(43) Pub. Date: Mar. 19, 2020

(54) ANTIFUNGAL COMPOSITION AND METHOD OF USE

(71) Applicant: BiOWiSH Technologies, Inc., Cincinnati, OH (US)

(72) Inventors: Michael Stanford SHOWELL, Cincinnati, OH (US); Richard S. CARPENTER, West Chester, OH (US); John P. GORSUCH, Cincinnati, OH (US)

(21) Appl. No.: 16/573,671

(22) Filed: Sep. 17, 2019

Related U.S. Application Data
(60) Provisional application No. 62/732,342, filed on Sep. 17, 2018.

(51) Int. Cl. A01N 63/04; A01N 63/02; A01N 25/12

(52) U.S. Cl. CPC A01N 63/04; A01N 25/12; A01N 63/02

(57) ABSTRACT

The present invention relates to an antifungal composition including Bacillus subtilis 34 KLB and Bacillus amyloliquefaciens. The antifungal composition can be used to treat a variety of diseases in plants, including Black Sigatoka, Fusarium wilt, and anthracnose.

### RELATED APPLICATION

This application claims priority to and the benefit of U.S. Application No. 62/732,342, filed on Sep. 17, 2018, the contents of which are incorporated by reference in their entirety.

### INCORPORATION BY REFERENCE OF SEQUENCE LISTING

The contents of the text file named “BIOW-019 SEQ LISTING.txt”, which was created on Sep. 16, 2019 and is 10.0 MB in size, are hereby incorporated by reference in their entireties.

### FIELD OF THE INVENTION

The present invention relates to antifungal compositions and the use thereof.

### BACKGROUND OF THE INVENTION

The use of antifungal agents to kill or prevent the growth of undesirable plant pathogenic organisms has been studied extensively. Although a number of antifungal agents are effective, they have drawbacks. For example, they can be very toxic and difficult to handle and not environmentally friendly, which limits their use. In addition, the problem of fungicide resistance may occur. Fungicide resistance occurs when a product is no longer effective at controlling a disease due to a shift in the genetics of the target pathogen organism. Fungicide resistance is due to natural selection of spores with less sensitivity due to either mutation or sexual recombination. It can be a very serious problem where fungicide resistance develops in a plant pathogen population.

There is a need for new antifungal compositions that are effective and environmentally friendly.

### SUMMARY OF THE INVENTION

One aspect of the present disclosure relates to an antifungal composition comprising a bacterial mixture, wherein the bacterial mixture consists essentially of Bacillus subtilis 34 KLB and Bacillus amyloliquefaciens at a ratio of about 10:1 to 1:10 by colony-forming unit (CFU), and wherein the antifungal composition can inhibit the growth of Ganoderma lucidum at least 10% more than either Bacillus subtilis 34 KLB or Bacillus amyloliquefaciens alone with the same CFU as the antifungal composition.

In some embodiments, the bacterial mixture is a powder. In some embodiments, each bacteria in the bacterial mixture is individually fermented, harvested, dried, and ground to produce a powder having a mean particle size of about 200 microns, with greater than 60% of the mixture in the size range between 100-800 microns.

In some embodiments, the bacterial mixture is a liquid.

In some embodiments, the antifungal composition has a bacterial concentration of 10⁹ to 10¹¹ CFU/g.

In some embodiments, the antifungal composition further comprises a water-soluble diluent. The water-soluble diluent can be selected from the group consisting of dextrose, maltodextrin, sucrose, sodium succinate, potassium succinate, fructose, mannose, lactose, maltose, dextrin, sorbitol, xylitol, inulin, trehalose, starch, cellobiose, carboxy methyl cellulose, dendritic salt, sodium sulfate, potassium sulfate, and a combination thereof.

The antifungal compositions disclosed herein can be used to treat a variety of diseases or conditions in plants.

One aspect of the present disclosure relates to a method of treating or preventing Black Sigatoka in a banana plant, the method comprising contacting the banana plant with the antifungal compositions disclosed herein.

One aspect of the present disclosure relates to a method of treating or preventing Fusarium wilt in a plant, the method comprising contacting the plant with the antifungal compositions disclosed herein. In some embodiments, the Fusarium wilt is caused by Fusarium oxysporum f. sp. cubense race 1 (Foc-1). Examples of plants include, but are not limited to, tomato, tobacco, legumes, cucurbits, sweet potatoes, mangos, Papayas, pineapple, coffee, spinach, and banana.

One aspect of the present disclosure relates to a method of treating or preventing anthracnose in a plant, the method comprising contacting the plant with the antifungal compositions disclosed herein. In some embodiments, the anthracnose is caused by Colletotrichum sp. Examples of plants include, but are not limited to, tomato, mango, Aloe, turfgrass, ash, birch, walnut, buckeye, elm, hornbeam, maple, oak, sycamore, Catalpa, dogwood, hickory, linden, and poplar.

One aspect of the present disclosure relates to a method of treating or preventing ghost spot in a plant, the method comprising contacting the plant with the antifungal compositions disclosed herein. In some embodiments, the ghost spot is caused by Cladosporium colocasiae. Examples of plants include, but are not limited to, tomato and taro.

One aspect of the present disclosure relates to a method of treating or preventing a leaf spot disease in a plant, the method comprising contacting the plant with the antifungal compositions disclosed herein. In some embodiments, the leaf spot disease is caused by Pseudocercospora ocimibasilici. Examples of plants include, but are not limited to, maple, tomato, turfgrass, ash, birch, walnut, buckeye, elm, hornbeam, oak, sycamore, Catalpa, dogwood, hickory, linden, mango, Papaya, and poplar.

One aspect of the present disclosure relates to a method of treating or preventing crown rot in a plant, the method comprising contacting the plant with the antifungal compositions disclosed herein. In some embodiments, the crown rot is caused by Colletotrichum musae, Chalara paradoxa, Fusarium pseudograminearum, Macrophomina phaseolina, or a combination thereof. Examples of plants include, but are not limited to, wheat, an apple tree, a cherry tree, a peach tree, banana, strawberry, and pineapple.

One aspect of the present disclosure relates to a method of treating or preventing stem blight in a plant, the method comprising contacting the plant with the antifungal compositions disclosed herein. In some embodiments, the stem blight is caused by Botrytis cinerea. Examples of plants include, but are not limited to, strawberries, fig, peach, and grapes.

One aspect of the present disclosure relates to a method of treating or preventing citrus mold in a plant, the method comprising contacting the plant with the antifungal compositions disclosed herein. In some embodiments, the citrus mold is caused by a Penicillium species. Examples of plants include, but are not limited to, orange, grapefruit, and lime.

One aspect of the present disclosure relates to a method of treating or preventing leaf blight in a plant, the method comprising contacting the plant with the antifungal compositions disclosed herein. In some embodiments, the leaf blight is caused by a Curvularia species, a Nigrospora species, a Phytophthora species, a Fusarium species, or a combination thereof. Examples of plants include, but are not limited to, turfgrass, taro, strawberry, almond, cherry, plum, apricot, and peach.

One aspect of the present disclosure relates to a method of treating or preventing fruit rot in a plant, the method comprising contacting the plant with the antifungal compositions disclosed herein. In some embodiments, the fruit rot is caused by a Mucor species. Examples of plants include, but are not limited to, tomatoes, potatoes, peppers, a fruit tree (e.g., apple or pear tree), and an ornamental plant.

One aspect of the present disclosure relates to a method of treating or preventing brown rot in a plant, the method comprising contacting the plant with the antifungal compositions disclosed herein. In some embodiments, the brown rot is caused by Mondinia fructicola. Examples of plants include, but are not limited to, a peach tree, an apricot tree, a plum tree, a nectarine tree, and cherries.

One aspect of the present disclosure relates to a method of treating or preventing black rot in a plant, the method comprising contacting the plant with the antifungal compositions disclosed herein. In some embodiments, the black rot is caused by Xanthomonas campestris, Xanothomonas campestris pv. Campestris, Guignardia bidwellii, or a combination thereof. Examples of plants include, but are not limited to, cyclamen, poinsettia, Primula, Impatiens, Begonia, Nicotiana, geranium, and sweet peas.

One aspect of the present disclosure relates to a method of treating or preventing gray mold in a plant, the method comprising contacting the plant with the antifungal compositions disclosed herein. In some embodiments, the gray mold is caused by a Botrytis species. Examples of plants include, but are not limited to, a grape plant, strawberry, peach, artichoke, asparagus, bean, beet, blackberry, and black-eyed pea.

One aspect of the present disclosure relates to a method of treating or preventing black mold in a plant, the method comprising contacting the plant with the antifungal compositions disclosed herein. In some embodiments, the black mold is caused by Alternaria solani, a Stemphyllium species, or a combination thereof. Examples of plants include, but are not limited to, a grape plant, tomato, and an ornamental plant.

One aspect of the present disclosure relates to a method of treating or preventing cigar-end rot in a plant, the method comprising contacting the plant with the antifungal compositions disclosed herein. In some embodiments, the cigar-end rot is caused by a Pestalotia species. Examples of plants include, but are not limited to, a banana plant, Liberian coffee tree, an avocado tree, and cocoa tree.

One aspect of the present disclosure relates to a method of treating or preventing blight caused by Xanthomonas axonopodis pv. dieffenbachiae in a plant, the method comprising contacting the plant with the antifungal compositions disclosed herein. Examples of plants include, but are not limited to, orange, pineapple, and lime.

One aspect of the present disclosure relates to a method of treating or preventing decay in a plant, the method comprising contacting the plant with the antifungal compositions disclosed herein. In some embodiments, the decay is caused by Acidovorax species, Enterobacter species, or a combination thereof. Examples of plants include, but are not limited to, watermelon, collard, and lettuce.

One aspect of the present disclosure relates to a method of treating or preventing late blight in tomatoes by Phythophthora infestans, the method comprising contacting tomato plants with the antifungal compositions disclosed herein.

One aspect of the present disclosure relates to a method of treating or preventing Cercospora leaf spot in a plant, the method comprising contacting the plant with the antifungal compositions disclosed herein. In some embodiments, the Cercospora leaf spot is caused by Cercospora ipomoea. Examples of plants include, but are not limited to, beach morning glory.

One aspect of the present disclosure relates to a method of treating or preventing branch canker and dieback in a plant, the method comprising contacting the plant with the antifungal compositions disclosed herein. In some embodiments, the branch canker and dieback is caused by Phoma sp. Examples of plants include, but are not limited to, milo.

One aspect of the present disclosure relates to a method of treating or preventing Verticillium wilt in a plant, the method comprising contacting the plant with the antifungal compositions disclosed herein. In some embodiments, the Verticillium wilt is caused by Verticillium dahliae. Examples of plants include, but are not limited to, strawberry.

One aspect of the present disclosure relates to a method of treating or preventing pineapple black rot in a plant, the method comprising contacting the plant with the antifungal compositions disclosed herein. In some embodiments, the pineapple black rot is caused by Chalara paradoxa, Ceratocystic paradoxa, Theilaviopsis paradoxa, or combinations thereof. Examples of plants include, but are not limited to, pineapple.

In some embodiments of any one of the above aspects, the plant is contacted with the antifungal composition monthly.

In some embodiments of any one of the above aspects, the method reduces the disease severity by at least 10% as compared to a control plant absent any treatment.

### BRIEF DESCRIPTION OF THE DRAWINGS

FIG. 1 shows the international disease assessment rating scale for Black Sigatoka and diagrams used to estimate percent disease on each treated leaf in this study.

FIG. 2 shows two approaches used to evaluate the inhibition of fungal growth in culture by BiOWiSH™ strains of bacteria: spotting a the test organism (e.g., Colletotrichum musae) in the center and spotting a BiOWiSH™ organism (e.g., BW283) to the left and right (left); and spotting culture plugs (e.g., Nigrospora sp.) on the growth medium 3 days after spotting the BiOWiSH™ organism (e.g., BW 283).

FIG. 3A shows a diagram of the procedure used to evaluate the growth of plant-pathogenic bacteria in culture by BiOWiSH™ strains of bacteria.

FIG. 3B shows the results of inhibition trials for two BiOWiSH™ strains (BW34 and BW283) for a plant-pathogenic (Enterobacter sp).

FIG. 4 shows the strong inhibition of Curvularia sp. by BiOWiSH™ strains BW34 (left) and BW283 (right) after 12 days at 22° C. The Curvularia sp. was taken from turfgrass with leaf blight and was cultured in 10% V8.

FIG. 5 shows no inhibition of P. palmivora by BiOWiSH™ strains BW34 (left) and BW283 (right) after 7 days at 23° C. The P. palmivora was taken from Papaya with fruit blight and was cultured in 10% V8.

FIG. 6 shows methods for determining in vitro plant-pathogen inhibition.

FIG. 7 shows the template used to measure appressed radial growth (mm) of fungal mycelium (left) and a petri dish displaying the radial mycelial growth of Botrytis cinerea in the presence of Bacillus amyloliquefaciens (right).

FIG. 8 shows a diagram of a Petri dish showing successful inhibition of a fungal plant pathogen by a bacterium (left) and a zone of inhibition produced by Bacillus amyloliquefaciens in the presence of Fusarium oxysporum f. sp. fragariae (right).

FIG. 9 shows the rating scale used to assess disease based on wilting and necrosis.

FIG. 10A shows a strawberry crown cross-section with degraded vascular tissue.

FIG. 10B shows growth of Macrophomina phaseolina out of the same crown after plating on acidified potato dextrose agar (APDA).

FIG. 11 shows results of laboratory tests for Black Rot disease control with BiOWiSH™.

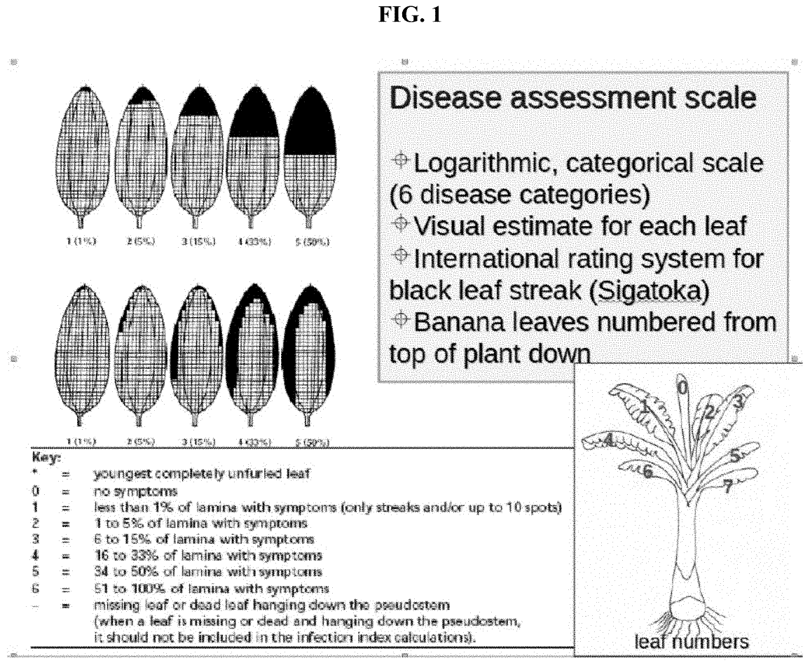

### DETAILED DESCRIPTION OF THE INVENTION

The present disclosure is based, inter alia, on the discovery that a mixture of two organisms—Bacillus subtilis 34 KLB and Bacillus amyloliquefaciens, provided better antifungal performance than existing grower practice based on fungicides.

In some embodiments, Bacillus subtilis 34 KLB has the following sequence.

Bacillus subtilis strain 34KLB
(SEQ ID NO.: 1)
AGCTCGGATCCACTAGTAACGGCCGCCAGTGTGCTGGAATTCGCCCTTAG
AAAGGAGGTGATCCAGCCGCACCTTCCGATACGGCTACCTTGTTACGACT
TCACCCCAATCATCTGTCCCACCTTCGGCGGCTGGCTCCATAAAGGTTAC
CTCACCGACTTCGGGTGTTACAAACTCTCGTGGTGTGACGGGCGGTGTGT
ACAAGGCCCGGGAACGTATTCACCGCGGCATGCTGATCCGCGATTACTAG
CGATTCCAGCTTCACGCAGTCGAGTTGCAGACTGCGATCCGAACTGAGAA
CAGATTTGTGRGATTGGCTTAACCTCGCGGTTTCGCTGCCCTTTGTTCTG
TCCATTGTAGCACGTGTGTAGCCCAGGTCATAPGGGGCATGATGATTTGA
CGTCATCCCCACCTTCCTCCGGTTTGTCACCGGCAGTCACCTTAGAGTGC
CCAACTGAATGCTGGCAACTAAGATCAAGGGTTGCGCTCGTTGCGGGACT
TAACCCAACATCTCACGACACGAGCTGACGACAACCATGCACCACCTGTC
ACTCTGCCCCCGAAGGGGACGTCCTATCTCTAGGATTGTCAGAGGATGTC
AAGACCTGGTAAGGTTCTTCGCGTTGCTTCGAATTAAACCACATGCTCCA
CCGCTTGTGCGGGCCCCCGTCAATTCCTTTGAGTTTCAGTCTTGCGACCG
TACTCCCCAGGCGGAGTGCTTAATGCGTTAGCTGCAGCACTAAAGGGGCG
GAAACCCCCTAACACTTAGCACTCATCGTTTACGGCGTGGACTACCAGGG
TATCTAATCCTGTTCGCTCCCCACGCTTTCGCTCCTCAGCGTCAGTTACA
GACCAGAGAGTCGCCTTCGCCACTGGTGTTCCTCCACATCTCTACGCATT
TCACCGCTACACGTGGAATTCCACTCTCCTCTTCTGCACTCAAGTTCCCC
AGTTTCCAATGACCCTCCCCGGTTGAGCCGGGGGCTTTCACATCAGACTT
AAGAAACCGCCTGCGAGCCCTTTACGCCCAATAAtTCCGGACAACGCTTG
CCACCTACGTATTACCGCGGCTGCTGGCACGTAGTTAGCCGTGGCTTTCT
GGTTAGGTACCGTCAAGGTGCCGCCCTATTTGAACGGCACTTGTTCTTCC
CTAACAACAGAGCTTTACGATCCGAAAACCTTCATCACTCACGCGGCGTT
GCTCCGTCAGACTTTCGTCCATTGCGGAAGATTCCCTACTGCTGCCTCCC
GTAGGAGTCTGGGCCGTGTCTCAGTCCCAGTGTGGCCGATCACCCTCTCA
GGTCGGCTACGCATCGTCGCCTTGGTGAGCCGTTACCTCACCAACTAGCT
AATGCGCCGCGGGTCCATCTGTAAGTGGTAGCCGAAGCCACCTTTTATGT
CTGAACCATGCGGTTCAGACAACCATCCGGTATTAGCCCCGGTTTCCCGG
AGTTATCCCAGTCTTACAGGCAGGTTACCCACGTGTTACTCACCCGTCCG
CCGCTAACATCAGGGAGCAAGCTCCCATCTGTCCGCTCGACTTGCATGTA
TTAGGCACGCCGCCAGCGTTCGTCCTGAGCCATGAACAAACTCTAAGGGC
GAATTCTGCAGATATCCATCACACTGGCGGCCGCTCGAGCATGCATCTAG
AGGGCCCAATCGCCCTAT

One aspect of the present disclosure relates to an antifungal composition including a bacterial mixture, wherein the bacterial mixture consists essentially of Bacillus subtilis 34 KLB and Bacillus amyloliquefaciens. In some embodiments, Bacillus subtilis 34 KLB and Bacillus amyloliquefaciens are present at a ratio of about 20:1 to 1:20 by colony-forming unit (CFU). In some embodiments, Bacillus subtilis 34 KLB and Bacillus amyloliquefaciens are present at a ratio of about 15:1 to 1:15 by CFU. In some embodiments, Bacillus subtilis 34 KLB and Bacillus amyloliquefaciens are present at a ratio of about 10:1 to 1:10 by CFU. In some embodiments, Bacillus subtilis 34 KLB and Bacillus amyloliquefaciens are present at a ratio of about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10 by CFU. In some embodiments, Bacillus subtilis 34 KLB and Bacillus amyloliquefaciens are present at a ratio of about 1:1 by CFU.

In some embodiments, Bacillus subtilis 34 KLB is the BW34 strain having any one of SEQ ID NO.: 2-19, or a combination thereof. In some embodiments, Bacillus amyloliquefaciens is the BW283 strain having any one of SEQ ID NO.: 20-136, or a combination thereof.

The antifungal composition can inhibit the growth of Ganoderma lucidum at least 10% more than either Bacillus subtilis 34 KLB or Bacillus amyloliquefaciens alone with the same CFU as the antifungal composition. In some embodiments, the antifungal composition can inhibit the growth of Ganoderma lucidum at least 50% more than either Bacillus subtilis 34 KLB or Bacillus amyloliquefaciens alone with the same CFU as the antifungal composition. In some embodiments, the antifungal composition can inhibit the growth of Ganoderma lucidum at least 80% more than either Bacillus subtilis 34 KLB or Bacillus amyloliquefaciens alone with the same CFU as the antifungal composition. In some embodiments, the antifungal composition can inhibit the growth of Ganoderma lucidum at least 90% more than either Bacillus subtilis 34 KLB or Bacillus amyloliquefaciens alone with the same CFU as the antifungal composition.

The antifungal composition can either be a powder or liquid. The antifungal composition can contain bacteria at a concentration between about 10⁶ and 10¹³ CFUs per gram, between about 10⁷ and 10¹³ CFUs per gram, between about 10⁸ and 10¹³ CFUs per gram, between about 10⁹ and 10¹³ CFUs per gram, between about 10¹⁰ and 10¹³ CFUs per gram, between about 10¹¹ and 10¹³ CFUs per gram, between about 10¹² and 10¹³ CFUs per gram, between about 10⁶ and 10¹² CFUs per gram, between about 10⁶ and 10¹¹ CFUs per gram, between about 10⁶ and 10¹⁰CFUs per gram, between about 10⁶ and 10⁹ CFUs per gram, between about 10⁶ and 10⁸ CFUs per gram, and between about 10⁶ and 10⁷ CFUs per gram. Preferably, the bacteria in the antifungal composition are at a concentration of at least 10⁹ CFUs per gram. In some embodiments, the bacteria are at a concentration of about 10⁹ to 10¹¹ CFUs per gram. Bacillus counts can be obtained, for example, on Trypticase soy agar.

In some embodiments, the antifungal composition can further include a water-soluble diluent. Non-limiting examples of water-soluble diluents include dextrose, maltodextrin, sucrose, sodium succinate, potassium succinate, fructose, mannose, lactose, maltose, dextrin, sorbitol, xylitol, inulin, trehalose, starch, cellobiose, carboxy methyl cellulose, dendritic salt, sodium sulfate, potassium sulfate, magnesium sulfate, sodium chloride, potassium chloride, calcium chloride, magnesium chloride, and a combination thereof. In some embodiments, the water-soluble diluent is dextrose monohydrate or anhydrous dextrose.

The antifungal composition can include at least 80% of a water-soluble diluent by weight. For example, the antifungal composition can include at least 80%, 85%, 90%, 91%, 92%, 93%, 94%, 95%, 96%, 97%, 98%, or 99% of the water-soluble diluent by weight.

The bacteria in the antifungal composition can be produced using any standard fermentation process known in the art, such as solid substrate or submerged liquid fermentation. The fermented cultures can be mixed cultures, microbiotic composites, or single isolates.

After fermentation, the bacteria are harvested by any known methods in the art. For example, the bacteria are harvested by filtration or centrifugation, or simply supplied as the ferment. The bacteria can be dried by any method known in the art. For example, the bacteria can be dried by liquid nitrogen followed by lyophilization. The compositions according to the present disclosure are freeze dried to moisture content less than 20%, 15%, 10%, 9%, 8%, 7%, 6%, 5%, 4%, 3%, 2%, or 1% by weight. Preferably, the compositions according to the invention have been freeze dried to moisture content less than 5% by weight. In some embodiments, the freeze-dried powder is ground to decrease the particle size. The bacteria can be ground by conical grinding at a temperature less than 10° C., 9° C., 8° C., 7° C., 6° C., 5° C., 4° C., 3° C., 2° C., 1° C., or 0° C. Preferably, the temperature is less than 4° C. For example, the particle size is less than 1500, 1400, 1300, 1200, 1100, 1000, 900, 800, 700, 600, 500, 400, 300, 200, or 100 microns. Preferably, the freeze-dried powder is ground to decrease the particle size such that the particle size is less than 800 microns. Most preferred are particle sizes less than about 400 microns. In most preferred embodiments, the dried powder has a mean particle size of 200 microns, with 60% of the mixture in the size range between 100-800 microns. The particle size can be measured using sieving according to ANSI/ASAE S319.4 method.

One aspect of the present disclosure relates to a method of treating or preventing Black Sigatoka in a banana plant, the method comprising contacting the banana plant with the antifungal compositions disclosed herein. Black Sigatoka is a severe foliar disease of banana (Musa spp.) caused by the plant-pathogenic fungus Mycosphaerella fijiensis. The appearance of disease symptoms on leaves is dynamic: lesions undergo changes in size, shape, and color as they expand and age.

In some embodiments, the method can reduce the severity of Black Sigatoka by at least 10% as compared to a control plant absent any treatment. In some embodiments, the method can reduce the severity of Black Sigatoka by at least 20% as compared to a control plant absent any treatment. In some embodiments, the method can reduce the severity of Black Sigatoka by at least 30% as compared to a control plant absent any treatment. In some embodiments, the method can reduce the severity of Black Sigatoka by at least 40% as compared to a control plant absent any treatment. In some embodiments, the method can reduce the severity of Black Sigatoka by at least 50% as compared to a control plant absent any treatment. In some embodiments, the method can reduce the severity of Black Sigatoka by at least 60% as compared to a control plant absent any treatment. In some embodiments, the method can reduce the severity of Black Sigatoka by at least 70% as compared to a control plant absent any treatment. In some embodiments, the method can reduce the severity of Black Sigatoka by at least 80% as compared to a control plant absent any treatment. In some embodiments, the method can reduce the severity of Black Sigatoka by at least 90% as compared to a control plant absent any treatment.

One aspect of the present disclosure relates to a method of treating or preventing Fusarium wilt (Panama Disease) in a plant, the method comprising contacting the plant with the antifungal compositions disclosed herein. Fusarium wilt is a common vascular wilt fungal disease, exhibiting symptoms similar to Verticillium wilt. The pathogen that causes Fusarium wilt is Fusarium oxysporum (F. oxysporum). Examples of plants include, but are not limited to, tomato, tobacco, legumes, cucurbits, sweet potatoes, mangos, Papayas, pineapple, coffee, spinach, and banana.

In some embodiments, the method can reduce the severity of Fusarium wilt by at least 10% as compared to a control plant absent any treatment. In some embodiments, the method can reduce the severity of Fusarium wilt by at least 20% as compared to a control plant absent any treatment. In some embodiments, the method can reduce the severity of Fusarium wilt by at least 30% as compared to a control plant absent any treatment. In some embodiments, the method can reduce the severity of Fusarium wilt by at least 40% as compared to a control plant absent any treatment. In some embodiments, the method can reduce the severity of Fusarium wilt by at least 50% as compared to a control plant absent any treatment. In some embodiments, the method can reduce the severity of Fusarium wilt by at least 60% as compared to a control plant absent any treatment. In some embodiments, the method can reduce the severity of Fusarium wilt by at least 70% as compared to a control plant absent any treatment. In some embodiments, the method can reduce the severity of Fusarium wilt by at least 80% as compared to a control plant absent any treatment. In some embodiments, the method can reduce the severity of Fusarium wilt by at least 90% as compared to a control plant absent any treatment.

One aspect of the present disclosure relates to a method of treating or preventing anthracnose in a plant, the method comprising contacting the plant with the antifungal compositions disclosed herein. In some embodiments, the anthracnose is caused by Colletotrichum sp. Anthracnose is a common disease that attacks a wide range of plants and trees. Examples of plants include, but are not limited to, tomato, mango, Aloe, turfgrass, ash, birch, walnut, buckeye, elm, hornbeam, maple, oak, sycamore, Catalpa, dogwood, hickory, linden, and poplar.

In some embodiments, the method can reduce the severity of anthracnose by at least 10% as compared to a control plant absent any treatment. In some embodiments, the method can reduce the severity of anthracnose by at least 20% as compared to a control plant absent any treatment. In some embodiments, the method can reduce the severity of anthracnose by at least 30% as compared to a control plant absent any treatment. In some embodiments, the method can reduce the severity of anthracnose by at least 40% as compared to a control plant absent any treatment. In some embodiments, the method can reduce the severity of anthracnose by at least 50% as compared to a control plant absent any treatment. In some embodiments, the method can reduce the severity of anthracnose by at least 60% as compared to a control plant absent any treatment. In some embodiments, the method can reduce the severity of anthracnose by at least 70% as compared to a control plant absent any treatment. In some embodiments, the method can reduce the severity of anthracnose by at least 80% as compared to a control plant absent any treatment. In some embodiments, the method can reduce the severity of anthracnose by at least 90% as compared to a control plant absent any treatment.

One aspect of the present disclosure relates to a method of treating or preventing ghost spot in a plant, the method comprising contacting the plant with the antifungal compositions disclosed herein. Ghost spot is a fungal disease of older leaves. In some embodiments, the ghost spot is caused by Cladosporium colocasiae. Examples of plants include, but are not limited to, tomato and taro.

In some embodiments, the method can reduce the severity of ghost spot by at least 10% as compared to a control plant absent any treatment. In some embodiments, the method can reduce the severity of ghost spot by at least 20% as compared to a control plant absent any treatment. In some embodiments, the method can reduce the severity of ghost spot by at least 30% as compared to a control plant absent any treatment. In some embodiments, the method can reduce the severity of ghost spot by at least 40% as compared to a control plant absent any treatment. In some embodiments, the method can reduce the severity of ghost spot by at least 50% as compared to a control plant absent any treatment. In some embodiments, the method can reduce the severity of ghost spot by at least 60% as compared to a control plant absent any treatment. In some embodiments, the method can reduce the severity of ghost spot by at least 70% as compared to a control plant absent any treatment. In some embodiments, the method can reduce the severity of ghost spot by at least 80% as compared to a control plant absent any treatment. In some embodiments, the method can reduce the severity of ghost spot by at least 90% as compared to a control plant absent any treatment.

One aspect of the present disclosure relates to a method of treating or preventing a leaf spot disease in a plant, the method comprising contacting the plant with the antifungal compositions disclosed herein. Leaf spots are round blemishes found on the leaves of many species of plants, mostly caused by parasitic fungi or bacteria. In some embodiments, the leaf spot disease is caused by Pseudocercospora ocimibasilici. Examples of plants include, but are not limited to, maple, tomato, turfgrass, ash, birch, walnut, buckeye, elm, hornbeam, oak, sycamore, Catalpa, dogwood, hickory, linden, mango, Papaya, and poplar.

In some embodiments, the method can reduce the severity of a leaf spot disease by at least 10% as compared to a control plant absent any treatment. In some embodiments, the method can reduce the severity of a leaf spot disease by at least 20% as compared to a control plant absent any treatment. In some embodiments, the method can reduce the severity of a leaf spot disease by at least 30% as compared to a control plant absent any treatment. In some embodiments, the method can reduce the severity of a leaf spot disease by at least 40% as compared to a control plant absent any treatment. In some embodiments, the method can reduce the severity of a leaf spot disease by at least 50% as compared to a control plant absent any treatment. In some embodiments, the method can reduce the severity of a leaf spot disease by at least 60% as compared to a control plant absent any treatment. In some embodiments, the method can reduce the severity of a leaf spot disease by at least 70% as compared to a control plant absent any treatment. In some embodiments, the method can reduce the severity of a leaf spot disease by at least 80% as compared to a control plant absent any treatment. In some embodiments, the method can reduce the severity of a leaf spot disease by at least 90% as compared to a control plant absent any treatment.

One aspect of the present disclosure relates to a method of treating or preventing crown rot in a plant, the method comprising contacting the plant with the antifungal compositions disclosed herein. Crown rot is caused by several soil-borne fungi. In some embodiments, the crown rot is caused by Colletotrichum musae, Chalara paradoxa, Fusarium pseudograminearum, Macrophomina phaseolina, or a combination thereof. Examples of plants include, but are not limited to, wheat, an apple tree, a cherry tree, a peach tree, banana, strawberry, and pineapple.

In some embodiments, the method can reduce the severity of crown rot by at least 10% as compared to a control plant absent any treatment. In some embodiments, the method can reduce the severity of crown rot by at least 20% as compared to a control plant absent any treatment. In some embodiments, the method can reduce the severity of crown rot by at least 30% as compared to a control plant absent any treatment. In some embodiments, the method can reduce the severity of crown rot by at least 40% as compared to a control plant absent any treatment. In some embodiments, the method can reduce the severity of crown rot by at least 50% as compared to a control plant absent any treatment. In some embodiments, the method can reduce the severity of crown rot by at least 60% as compared to a control plant absent any treatment. In some embodiments, the method can reduce the severity of crown rot by at least 70% as compared to a control plant absent any treatment. In some embodiments, the method can reduce the severity of crown rot by at least 80% as compared to a control plant absent any treatment. In some embodiments, the method can reduce the severity of crown rot by at least 90% as compared to a control plant absent any treatment.

One aspect of the present disclosure relates to a method of treating or preventing stem blight in a plant, the method comprising contacting the plant with the antifungal compositions disclosed herein. In some embodiments, the stem blight is caused by Botrytis cinerea or Didymella bryoniae. Examples of plants include, but are not limited to, strawberries, fig, peach, and grapes.

In some embodiments, the method can reduce the severity of stem blight by at least 10% as compared to a control plant absent any treatment. In some embodiments, the method can reduce the severity of stem blight by at least 20% as compared to a control plant absent any treatment. In some embodiments, the method can reduce the severity of stem blight by at least 30% as compared to a control plant absent any treatment. In some embodiments, the method can reduce the severity of stem blight by at least 40% as compared to a control plant absent any treatment. In some embodiments, the method can reduce the severity of stem blight by at least 50% as compared to a control plant absent any treatment. In some embodiments, the method can reduce the severity of stem blight by at least 60% as compared to a control plant absent any treatment. In some embodiments, the method can reduce the severity of stem blight by at least 70% as compared to a control plant absent any treatment. In some embodiments, the method can reduce the severity of stem blight by at least 80% as compared to a control plant absent any treatment. In some embodiments, the method can reduce the severity of stem blight by at least 90% as compared to a control plant absent any treatment.

One aspect of the present disclosure relates to a method of treating or preventing citrus mold in a plant, the method comprising contacting the plant with the antifungal compositions disclosed herein. In some embodiments, the citrus mold is caused by a Penicillium species such as Penicillium digitatum. Examples of plants include, but are not limited to, orange, grapefruit, tangerine, lemon, and lime.

In some embodiments, the method can reduce the severity of citrus mold by at least 10% as compared to a control plant absent any treatment. In some embodiments, the method can reduce the severity of citrus mold by at least 20% as compared to a control plant absent any treatment. In some embodiments, the method can reduce the severity of citrus mold by at least 30% as compared to a control plant absent any treatment. In some embodiments, the method can reduce the severity of citrus mold by at least 40% as compared to a control plant absent any treatment. In some embodiments, the method can reduce the severity of citrus mold by at least 50% as compared to a control plant absent any treatment. In some embodiments, the method can reduce the severity of citrus mold by at least 60% as compared to a control plant absent any treatment. In some embodiments, the method can reduce the severity of citrus mold by at least 70% as compared to a control plant absent any treatment. In some embodiments, the method can reduce the severity of citrus mold by at least 80% as compared to a control plant absent any treatment. In some embodiments, the method can reduce the severity of citrus mold by at least 90% as compared to a control plant absent any treatment.

One aspect of the present disclosure relates to a method of treating or preventing leaf blight in a plant, the method comprising contacting the plant with the antifungal compositions disclosed herein. In some embodiments, the leaf blight is caused by a Curvularia species, a Nigrospora species, a Phytophthora species, a Fusarium species, or a combination thereof. Examples of plants include, but are not limited to, turfgrass, taro, strawberry, almond, cherry, plum, apricot, and peach.

In some embodiments, the method can reduce the severity of leaf blight by at least 10% as compared to a control plant absent any treatment. In some embodiments, the method can reduce the severity of leaf blight by at least 20% as compared to a control plant absent any treatment. In some embodiments, the method can reduce the severity of leaf blight by at least 30% as compared to a control plant absent any treatment. In some embodiments, the method can reduce the severity of leaf blight by at least 40% as compared to a control plant absent any treatment. In some embodiments, the method can reduce the severity of leaf blight by at least 50% as compared to a control plant absent any treatment. In some embodiments, the method can reduce the severity of leaf blight by at least 60% as compared to a control plant absent any treatment. In some embodiments, the method can reduce the severity of leaf blight by at least 70% as compared to a control plant absent any treatment. In some embodiments, the method can reduce the severity of leaf blight by at least 80% as compared to a control plant absent any treatment. In some embodiments, the method can reduce the severity of leaf blight by at least 90% as compared to a control plant absent any treatment.

One aspect of the present disclosure relates to a method of treating or preventing fruit rot in a plant, the method comprising contacting the plant with the antifungal compositions disclosed herein. In some embodiments, the fruit rot is caused by a Mucor species such as Mucor piriformis. Examples of plants include, but are not limited to, tomatoes, potatoes, peppers, a fruit tree (e.g., apple or pear tree), and an ornamental plant.

In some embodiments, the method can reduce the severity of fruit rot by at least 10% as compared to a control plant absent any treatment. In some embodiments, the method can reduce the severity of fruit rot by at least 20% as compared to a control plant absent any treatment. In some embodiments, the method can reduce the severity of fruit rot by at least 30% as compared to a control plant absent any treatment. In some embodiments, the method can reduce the severity of fruit rot by at least 40% as compared to a control plant absent any treatment. In some embodiments, the method can reduce the severity of fruit rot by at least 50% as compared to a control plant absent any treatment. In some embodiments, the method can reduce the severity of fruit rot by at least 60% as compared to a control plant absent any treatment. In some embodiments, the method can reduce the severity of fruit rot by at least 70% as compared to a control plant absent any treatment. In some embodiments, the method can reduce the severity of fruit rot by at least 80% as compared to a control plant absent any treatment. In some embodiments, the method can reduce the severity of fruit rot by at least 90% as compared to a control plant absent any treatment.

One aspect of the present disclosure relates to a method of treating or preventing brown rot in a plant, the method comprising contacting the plant with the antifungal compositions disclosed herein. Brown rot is a fungal disease that commonly affects stone-fruit trees like peaches and cherries. In some embodiments, the brown rot is caused by Monilinia fructicola. Examples of plants include, but are not limited to, a peach tree, an apricot tree, a plum tree, a nectarine tree, and cherries.

In some embodiments, the method can reduce the severity of brown rot by at least 10% as compared to a control plant absent any treatment. In some embodiments, the method can reduce the severity of brown rot by at least 20% as compared to a control plant absent any treatment. In some embodiments, the method can reduce the severity of brown rot by at least 30% as compared to a control plant absent any treatment. In some embodiments, the method can reduce the severity of brown rot by at least 40% as compared to a control plant absent any treatment. In some embodiments, the method can reduce the severity of brown rot by at least 50% as compared to a control plant absent any treatment. In some embodiments, the method can reduce the severity of brown rot by at least 60% as compared to a control plant absent any treatment. In some embodiments, the method can reduce the severity of brown rot by at least 70% as compared to a control plant absent any treatment. In some embodiments, the method can reduce the severity of brown rot by at least 80% as compared to a control plant absent any treatment. In some embodiments, the method can reduce the severity of brown rot by at least 90% as compared to a control plant absent any treatment.

One aspect of the present disclosure relates to a method of treating or preventing black rot in a plant, the method comprising contacting the plant with the antifungal compositions disclosed herein. Black rot is a name used for various diseases of cultivated plants caused by fungi or bacteria, producing dark brown discoloration and decay in the leaves of fruit and vegetables: (a) a disease of the apple, pear and quince caused by a fungus (Botryosphaeria obtusa or Physalospora cydoniae); (b) a disease of the apple, pear and quince caused by a fungus (Botryosphaeria obtusa or Physalospora cydoniae); (c) a disease of cabbage and related plants caused by a bacterium (Xanthomonas campestris pv. campestris); (d) a disease of the potato caused by a bacterium (Erwinia atroseptica); (e) a disease of citrus plants caused by a fungus (Alternaria citri); and (f) a disease of the sweet potato caused by a fungus (Ceratostomella fimbriata). In some embodiments, the black rot is caused by Xanthomonas campestris, Xanothomonas campestris pv. Campestris, Guignardia bidwellii, or a combination thereof. Examples of plants include, but are not limited to, cyclamen, poinsettia, Primula, Impatiens, Begonia, Nicotiana, geranium, and sweet peas.

In some embodiments, the method can reduce the severity of black rot by at least 10% as compared to a control plant absent any treatment. In some embodiments, the method can reduce the severity of black rot by at least 20% as compared to a control plant absent any treatment. In some embodiments, the method can reduce the severity of black rot by at least 30% as compared to a control plant absent any treatment. In some embodiments, the method can reduce the severity of black rot by at least 40% as compared to a control plant absent any treatment. In some embodiments, the method can reduce the severity of black rot by at least 50% as compared to a control plant absent any treatment. In some embodiments, the method can reduce the severity of black rot by at least 60% as compared to a control plant absent any treatment. In some embodiments, the method can reduce the severity of black rot by at least 70% as compared to a control plant absent any treatment. In some embodiments, the method can reduce the severity of black rot by at least 80% as compared to a control plant absent any treatment. In some embodiments, the method can reduce the severity of black rot by at least 90% as compared to a control plant absent any treatment.

One aspect of the present disclosure relates to a method of treating or preventing gray mold in a plant, the method comprising contacting the plant with the antifungal compositions disclosed herein. In some embodiments, the gray mold is caused by a Botrytis species such as Botrytis cinerea. Examples of plants include, but are not limited to, a grape plant, strawberry, peach, artichoke, asparagus, bean, beet, blackberry, and black-eyed pea.

In some embodiments, the method can reduce the severity of gray mold by at least 10% as compared to a control plant absent any treatment. In some embodiments, the method can reduce the severity of gray mold by at least 20% as compared to a control plant absent any treatment. In some embodiments, the method can reduce the severity of gray mold by at least 30% as compared to a control plant absent any treatment. In some embodiments, the method can reduce the severity of gray mold by at least 40% as compared to a control plant absent any treatment. In some embodiments, the method can reduce the severity of gray mold by at least 50% as compared to a control plant absent any treatment. In some embodiments, the method can reduce the severity of gray mold by at least 60% as compared to a control plant absent any treatment. In some embodiments, the method can reduce the severity of gray mold by at least 70% as compared to a control plant absent any treatment. In some embodiments, the method can reduce the severity of gray mold by at least 80% as compared to a control plant absent any treatment. In some embodiments, the method can reduce the severity of gray mold by at least 90% as compared to a control plant absent any treatment.

One aspect of the present disclosure relates to a method of treating or preventing black mold in a plant, the method comprising contacting the plant with the antifungal compositions disclosed herein. Black mold symptoms vary from small, superficial, brown flecks to large, sunken, black lesions. In some embodiments, the black mold is caused by Alternaria solani, a Stemphyllium species, or a combination thereof. Examples of plants include, but are not limited to, a grape plant, tomato, and an ornamental plant.

In some embodiments, the method can reduce the severity of black mold by at least 10% as compared to a control plant absent any treatment. In some embodiments, the method can reduce the severity of black mold by at least 20% as compared to a control plant absent any treatment. In some embodiments, the method can reduce the severity of black mold by at least 30% as compared to a control plant absent any treatment. In some embodiments, the method can reduce the severity of black mold by at least 40% as compared to a control plant absent any treatment. In some embodiments, the method can reduce the severity of black mold by at least 50% as compared to a control plant absent any treatment. In some embodiments, the method can reduce the severity of black mold by at least 60% as compared to a control plant absent any treatment. In some embodiments, the method can reduce the severity of black mold by at least 70% as compared to a control plant absent any treatment. In some embodiments, the method can reduce the severity of black mold by at least 80% as compared to a control plant absent any treatment. In some embodiments, the method can reduce the severity of black mold by at least 90% as compared to a control plant absent any treatment.

One aspect of the present disclosure relates to a method of treating or preventing cigar-end rot in a plant, the method comprising contacting the plant with the antifungal compositions disclosed herein. In some embodiments, the cigar-end rot is caused by a Pestalotia species, Verticillium theobromas, Trachysphaera fructigena, or a combination thereof. Examples of plants include, but are not limited to, a banana plant, Liberian coffee tree, an avocado tree, and cocoa tree.

In some embodiments, the method can reduce the severity of cigar-end rot by at least 10% as compared to a control plant absent any treatment. In some embodiments, the method can reduce the severity of cigar-end rot by at least 20% as compared to a control plant absent any treatment. In some embodiments, the method can reduce the severity of cigar-end rot by at least 30% as compared to a control plant absent any treatment. In some embodiments, the method can reduce the severity of cigar-end rot by at least 40% as compared to a control plant absent any treatment. In some embodiments, the method can reduce the severity of cigar-end rot by at least 50% as compared to a control plant absent any treatment. In some embodiments, the method can reduce the severity of cigar-end rot by at least 60% as compared to a control plant absent any treatment. In some embodiments, the method can reduce the severity of cigar-end rot by at least 70% as compared to a control plant absent any treatment. In some embodiments, the method can reduce the severity of cigar-end rot by at least 80% as compared to a control plant absent any treatment. In some embodiments, the method can reduce the severity of cigar-end rot by at least 90% as compared to a control plant absent any treatment.

One aspect of the present disclosure relates to a method of treating or preventing blight caused by Xanthomonas axonopodis pv. dieffenbachiae in a plant, the method comprising contacting the plant with the antifungal compositions disclosed herein. Examples of plants include, but are not limited to, orange, pineapple, and lime.

In some embodiments, the method can reduce the severity of blight caused by Xanthomonas axonopodis pv. dieffenbachiae by at least 10% as compared to a control plant absent any treatment. In some embodiments, the method can reduce the severity of blight caused by Xanthomonas axonopodis pv. dieffenbachiae by at least 20% as compared to a control plant absent any treatment. In some embodiments, the method can reduce the severity of blight caused by Xanthomonas axonopodis pv. dieffenbachiae by at least 30% as compared to a control plant absent any treatment. In some embodiments, the method can reduce the severity of blight caused by Xanthomonas axonopodis pv. dieffenbachiae by at least 40% as compared to a control plant absent any treatment. In some embodiments, the method can reduce the severity of blight caused by Xanthomonas axonopodis pv. dieffenbachiae by at least 50% as compared to a control plant absent any treatment. In some embodiments, the method can reduce the severity of blight caused by Xanthomonas axonopodis pv. dieffenbachiae by at least 60% as compared to a control plant absent any treatment. In some embodiments, the method can reduce the severity of blight caused by Xanthomonas axonopodis pv. dieffenbachiae by at least 70% as compared to a control plant absent any treatment. In some embodiments, the method can reduce the severity of blight caused by Xanthomonas axonopodis pv. dieffenbachiae by at least 80% as compared to a control plant absent any treatment. In some embodiments, the method can reduce the severity of blight caused by Xanthomonas axonopodis pv. dieffenbachiae by at least 90% as compared to a control plant absent any treatment.

One aspect of the present disclosure relates to a method of treating or preventing decay caused by an Acidovorax species in a plant, the method comprising contacting the plant with the antifungal compositions disclosed herein. In some embodiments, the plant is watermelon.

In some embodiments, the method can reduce the severity of decay caused by an Acidovorax species by at least 10% as compared to a control plant absent any treatment. In some embodiments, the method can reduce the severity of decay caused by an Acidovorax species by at least 20% as compared to a control plant absent any treatment. In some embodiments, the method can reduce the severity of decay caused by an Acidovorax species by at least 30% as compared to a control plant absent any treatment. In some embodiments, the method can reduce the severity of decay caused by an Acidovorax species by at least 40% as compared to a control plant absent any treatment. In some embodiments, the method can reduce the severity of decay caused by an Acidovorax species by at least 50% as compared to a control plant absent any treatment. In some embodiments, the method can reduce the severity of decay caused by an Acidovorax species by at least 60% as compared to a control plant absent any treatment. In some embodiments, the method can reduce the severity of decay caused by an Acidovorax species by at least 70% as compared to a control plant absent any treatment. In some embodiments, the method can reduce the severity of decay caused by an Acidovorax species by at least 80% as compared to a control plant absent any treatment. In some embodiments, the method can reduce the severity of decay caused by an Acidovorax species by at least 90% as compared to a control plant absent any treatment.

One aspect of the present disclosure relates to a method of treating or preventing late blight in a plant, the method comprising contacting the plant with the antifungal compositions disclosed herein. In some embodiments, the late blight is caused by a Phytophthora infestans, Phytophthora colocasiae, or combinations thereof. Examples of plants include, but are not limited to, tomatoes, potatoes, and taro.

In some embodiments, the method can reduce the severity of late blight caused by Phytophthora infestans by at least 10% as compared to a control plant absent any treatment. In some embodiments, the method can reduce the severity of late blight caused by Phytophthora infestans by at least 20% as compared to a control plant absent any treatment. In some embodiments, the method can reduce the severity of late blight caused by Phytophthora infestans by at least 30% as compared to a control plant absent any treatment. In some embodiments, the method can reduce the severity of late blight caused by Phytophthora infestans by at least 40% as compared to a control plant absent any treatment. In some embodiments, the method can reduce the severity of late blight caused by Phytophthora infestans by at least 50% as compared to a control plant absent any treatment. In some embodiments, the method can reduce the severity of late blight caused by Phytophthora infestans by at least 60% as compared to a control plant absent any treatment. In some embodiments, the method can reduce the severity of late blight caused by Phytophthora infestans by at least 70% as compared to a control plant absent any treatment. In some embodiments, the method can reduce the severity of late blight caused by Phytophthora infestans by at least 80% as compared to a control plant absent any treatment. In some embodiments, the method can reduce the severity of late blight caused by Phytophthora infestans by at least 90% as compared to a control plant absent any treatment.

One aspect of the present disclosure relates to a method of treating or preventing Cercospora leaf spot in a plant, the method comprising contacting the plant with the antifungal compositions disclosed herein. In some embodiments, the Cercospora leaf spot is caused by Cercospora ipomoea. Examples of plants include, but are not limited to, beach morning glory. In some embodiments, the method can reduce the severity of Cercospora leaf spot caused by Cercospora ipomoea by at least 10% as compared to a control plant absent any treatment. In some embodiments, the method can reduce the severity of Cercospora leaf spot caused by Cercospora ipomoea by at least 20% as compared to a control plant absent any treatment. In some embodiments, the method can reduce the severity of Cercospora leaf spot caused by Cercospora ipomoea by at least 30% as compared to a control plant absent any treatment. In some embodiments, the method can reduce the severity of Cercospora leaf spot caused by Cercospora ipomoea by at least 40% as compared to a control plant absent any treatment. In some embodiments, the method can reduce the severity of Cercospora leaf spot caused by Cercospora ipomoea by at least 50% as compared to a control plant absent any treatment. In some embodiments, the method can reduce the severity of Cercospora leaf spot caused by Cercospora ipomoea by at least 60% as compared to a control plant absent any treatment. In some embodiments, the method can reduce the severity of Cercospora leaf spot caused by Cercospora ipomoea by at least 70% as compared to a control plant absent any treatment. In some embodiments, the method can reduce the severity of Cercospora leaf spot caused by Cercospora ipomoea by at least 80% as compared to a control plant absent any treatment. In some embodiments, the method can reduce the severity of Cercospora leaf spot caused by Cercospora ipomoea by at least 90% as compared to a control plant absent any treatment.

One aspect of the present disclosure relates to a method of treating or preventing branch canker and dieback in a plant, the method comprising contacting the plant with the antifungal compositions disclosed herein. In some embodiments, the branch canker and dieback is caused by Phoma sp. The antifungal compositions can inhibit or reduce the reproduction of Phoma sp. Examples of plants include, but are not limited to, milo.

In some embodiments, the method can reduce the severity of branch canker and dieback caused by Phoma species by at least 10% as compared to a control plant absent any treatment. In some embodiments, the method can reduce the severity of branch canker and dieback caused by Phoma species by at least 20% as compared to a control plant absent any treatment. In some embodiments, the method can reduce the severity of branch canker and dieback caused by Phoma species by at least 30% as compared to a control plant absent any treatment. In some embodiments, the method can reduce the severity of branch canker and dieback caused by Phoma species by at least 40% as compared to a control plant absent any treatment. In some embodiments, the method can reduce the severity of branch canker and dieback caused by Phoma species by at least 50% as compared to a control plant absent any treatment. In some embodiments, the method can reduce the severity of branch canker and dieback caused by Phoma species by at least 60% as compared to a control plant absent any treatment. In some embodiments, the method can reduce the severity of branch canker and dieback caused by Phoma species by at least 70% as compared to a control plant absent any treatment. In some embodiments, the method can reduce the severity of branch canker and dieback caused by Phoma species by at least 80% as compared to a control plant absent any treatment. In some embodiments, the method can reduce the severity of branch canker and dieback caused by Phoma species by at least 90% as compared to a control plant absent any treatment.

One aspect of the present disclosure relates to a method of treating or preventing Verticillium wilt in a plant, the method comprising contacting the plant with the antifungal compositions disclosed herein. In some embodiments, the Verticillium wilt is caused by Verticillium dahliae. Examples of plants include, but are not limited to, strawberry.

In some embodiments, the method can reduce the severity of Verticillium wilt caused by Verticillium species by at least 10% as compared to a control plant absent any treatment. In some embodiments, the method can reduce the severity of Verticillium wilt caused by Verticillium species by at least 20% as compared to a control plant absent any treatment. In some embodiments, the method can reduce the severity of Verticillium wilt caused by Verticillium species by at least 30% as compared to a control plant absent any treatment. In some embodiments, the method can reduce the severity of Verticillium wilt caused by Verticillium species by at least 40% as compared to a control plant absent any treatment. In some embodiments, the method can reduce the severity of Verticillium wilt caused by Verticillium species by at least 50% as compared to a control plant absent any treatment. In some embodiments, the method can reduce the severity of Verticillium wilt caused by Verticillium species by at least 60% as compared to a control plant absent any treatment. In some embodiments, the method can reduce the severity of Verticillium wilt caused by Verticillium species by at least 70% as compared to a control plant absent any treatment. In some embodiments, the method can reduce the severity of Verticillium wilt caused by Verticillium species by at least 80% as compared to a control plant absent any treatment. In some embodiments, the method can reduce the severity of Verticillium wilt caused by Verticillium species by at least 90% as compared to a control plant absent any treatment.

One aspect of the present disclosure relates to a method of treating or preventing pineapple black rot in a plant, the method comprising contacting the plant with the antifungal compositions disclosed herein. In some embodiments, the pineapple black rot is caused by Chalara paradoxa, Ceratocystic paradoxa, Theilaviopsis paradoxa, or combinations thereof. Examples of plants include, but are not limited to, pineapple.

In some embodiments, the method can reduce the severity of pineapple black rot caused by Chalara species by at least 10% as compared to a control plant absent any treatment. In some embodiments, the method can reduce the severity of pineapple black rot caused by Chalara species by at least 20% as compared to a control plant absent any treatment. In some embodiments, the method can reduce the severity of pineapple black rot caused by Chalara species by at least 30% as compared to a control plant absent any treatment. In some embodiments, the method can reduce the severity of pineapple black rot caused by Chalara species by at least 40% as compared to a control plant absent any treatment. In some embodiments, the method can reduce the severity of pineapple black rot caused by Chalara species by at least 50% as compared to a control plant absent any treatment. In some embodiments, the method can reduce the severity of pineapple black rot caused by Chalara species by at least 60% as compared to a control plant absent any treatment. In some embodiments, the method can reduce the severity of pineapple black rot caused by Chalara species by at least 70% as compared to a control plant absent any treatment. In some embodiments, the method can reduce the severity of pineapple black rot caused by Chalara species by at least 80% as compared to a control plant absent any treatment. In some embodiments, the method can reduce the severity of pineapple black rot caused by Chalara species by at least 90% as compared to a control plant absent any treatment.

In some embodiments, the method can reduce the severity of pineapple black rot caused by Ceratocystic species by at least 10% as compared to a control plant absent any treatment. In some embodiments, the method can reduce the severity of pineapple black rot caused by Ceratocystic species by at least 20% as compared to a control plant absent any treatment. In some embodiments, the method can reduce the severity of pineapple black rot caused by Ceratocystic species by at least 30% as compared to a control plant absent any treatment. In some embodiments, the method can reduce the severity of pineapple black rot caused by Ceratocystic species by at least 40% as compared to a control plant absent any treatment. In some embodiments, the method can reduce the severity of pineapple black rot caused by Ceratocystic species by at least 50% as compared to a control plant absent any treatment. In some embodiments, the method can reduce the severity of pineapple black rot caused by Ceratocystic species by at least 60% as compared to a control plant absent any treatment. In some embodiments, the method can reduce the severity of pineapple black rot caused by Ceratocystic species by at least 70% as compared to a control plant absent any treatment. In some embodiments, the method can reduce the severity of pineapple black rot caused by Ceratocystic species by at least 80% as compared to a control plant absent any treatment. In some embodiments, the method can reduce the severity of pineapple black rot caused by Ceratocystic species by at least 90% as compared to a control plant absent any treatment.

In some embodiments, the method can reduce the severity of pineapple black rot caused by Theilaviopsis species by at least 10% as compared to a control plant absent any treatment. In some embodiments, the method can reduce the severity of pineapple black rot caused by Theilaviopsis species by at least 20% as compared to a control plant absent any treatment. In some embodiments, the method can reduce the severity of pineapple black rot caused by Theilaviopsis species by at least 30% as compared to a control plant absent any treatment. In some embodiments, the method can reduce the severity of pineapple black rot caused by Theilaviopsis species by at least 40% as compared to a control plant absent any treatment. In some embodiments, the method can reduce the severity of pineapple black rot caused by Theilaviopsis species by at least 50% as compared to a control plant absent any treatment. In some embodiments, the method can reduce the severity of pineapple black rot caused by Theilaviopsis species by at least 60% as compared to a control plant absent any treatment. In some embodiments, the method can reduce the severity of pineapple black rot caused by Theilaviopsis species by at least 70% as compared to a control plant absent any treatment. In some embodiments, the method can reduce the severity of pineapple black rot caused by Theilaviopsis species by at least 80% as compared to a control plant absent any treatment. In some embodiments, the method can reduce the severity of pineapple black rot caused by Theilaviopsis species by at least 90% as compared to a control plant absent any treatment. Novel approaches to managing soil-borne diseases of strawberry are in need due to the phase-out and increased regulation of commonly used soil fumigants such as methyl bromide and chloropicrin. Accordingly, one aspect of the present disclosure relates to a method of treating or preventing a soil-borne disease in strawberries, the method comprising contacting the plant with the antifungal compositions disclosed herein. The soil-borne disease can be caused by Botrytis cinerea, Fusarium oxysporum f. sp. fragariae, Macrophomina phaseolina, Verticillium dahliae, and a combination thereof.

In some embodiments, the method can reduce the severity of the soil-borne disease in strawberries by at least 10% as compared to a control plant absent any treatment. In some embodiments, the method can reduce the severity of the soil-borne disease in strawberries by at least 20% as compared to a control plant absent any treatment. In some embodiments, the method can reduce the severity of the soil-borne disease in strawberries by at least 30% as compared to a control plant absent any treatment. In some embodiments, the method can reduce the severity of the soil-borne disease in strawberries by at least 40% as compared to a control plant absent any treatment. In some embodiments, the method can reduce the severity of the soil-borne disease in strawberries by at least 50% as compared to a control plant absent any treatment. In some embodiments, the method can reduce the severity of the soil-borne disease in strawberries by at least 60% as compared to a control plant absent any treatment. In some embodiments, the method can reduce the severity of the soil-borne disease in strawberries by at least 70% as compared to a control plant absent any treatment. In some embodiments, the method can reduce the severity of the soil-borne disease in strawberries by at least 80% as compared to a control plant absent any treatment. In some embodiments, the method can reduce the severity of the soil-borne disease in strawberries by at least 90% as compared to a control plant absent any treatment.

The plant can be contacted with the antifungal composition by spraying the antifungal composition onto the plant.

In some embodiments of any one of the above aspects, the plant is contacted with the antifungal composition daily. The contacting can be done throughout the fruit growth cycle.

In some embodiments of any one of the above aspects, the plant is contacted with the antifungal composition once every few days, e.g., once per week. The contacting can be done throughout the fruit growth cycle.

In some embodiments of any one of the above aspects, the plant is contacted with the antifungal composition monthly. The contacting can be done throughout the fruit growth cycle.

The suspension that is used to contact the plant with can include about 0.1-10 grams of the dry antifungal composition per gallon of water. For example, the suspension can include about 0.5 gram, 1 gram, 1.5 grams, 2 grams, 2.5 grams, 3 grams, 3.5 grams, 4 grams, 4.5 grams, 5 grams, 5.5 grams, or 6 grams of the dry antifungal composition per gallon of water.

The antifungal composition of the present disclosure can be used in combination with one or more fungicides. Non-limiting examples of fungicides include mancozeb, maneb, fenbuconazole, propiconazole (Tilt), azoxystrobin, tebuconazole, methyl bromide, chloropicrin, and petroleum distillates.

The details of the invention are set forth in the accompanying description below. Although methods and materials similar or equivalent to those described herein can be used in the practice or testing of the present invention, illustrative methods and materials are now described. Other features, objects, and advantages of the invention will be apparent from the description and from the claims. In the specification and the appended claims, the singular forms also include the plural unless the context clearly dictates otherwise. Unless defined otherwise, all technical and scientific terms used herein have the same meaning as commonly understood by one of ordinary skill in the art to which this invention belongs. All patents and publications cited in this specification are incorporated herein by reference in their entireties.

### Definitions

The term “comprising” as used herein is synonymous with “including” or “containing” and is inclusive or open-ended and does not exclude additional, unrecited members, elements or method steps. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. In some embodiments, the phrase “consisting essentially of” refers to a bacterial mixture having 5% or less (e.g., 5% or less, 4% or less, 3% or less, 2% or less, or 1% or less) by CFU of a bacterial species other than Bacillus subtilis 34 KLB and Bacillus amyloliquefaciens.

The articles “a” and “an” are used in this disclosure to refer to one or more than one (i.e., to at least one) of the grammatical object of the article. By way of example, “an element” means one element or more than one element.

The term “and/or” is used in this disclosure to mean either “and” or “or” unless indicated otherwise.

The term “treating”, as used herein, unless otherwise indicated, means reversing, alleviating, inhibiting the progress of, delaying the progression of, the disease or condition to which such term applies, or one or more symptoms of such disease or condition.

The term “preventing” refers to an inhibition or delay in the onset of at least one symptom of a disease or condition.

The term “severity” when used to describe a disease refers to the percentage of relevant host tissues or organ covered by symptoms or lesion or damaged by the disease. In some embodiments, standard area diagrams can be used to estimate disease severity by comparing the diseased leaves with the pictorial representation of the host plant with known and graded amounts of the same disease. For assessing the disease severity, the descriptive keys are standardized and/or given numerical ratings for the specific disease.

The term “about” means within ±10% of a given value or range.

### Examples

The disclosure is further illustrated by the following examples, which are not to be construed as limiting this disclosure in scope or spirit to the specific procedures herein described. It is to be understood that the examples are provided to illustrate certain embodiments and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

### Example 1. Black Sigatoka Control in Hawaii

Most farmers in Black Sigatoka-prone regions of Hawaii use one or more fungicides to manage the disease. The most commonly used products, used alone, in rotations, or in combinations, include the active ingredients mancozeb, maneb, fenbuconazole, propiconazole (Tilt), azoxystrobin, tebuconazole, and petroleum distillates (oils). Petroleum distillates work very well in combination with sanitation (de-trashing). Growers often either mix or rotate fungicides with different modes of action, such as tank mixes of protectant type fungicides (e.g., mancozeb or manzate) with systemic fungicides (e.g., fenbuconazole or tebuconazole).

One of the objectives is to evaluate two BiOWiSH™ products (“Prototype” (Bacillus subtilis 34 KLB and Bacillus amyloliquefaciens at a ratio of about 1:1 by CFU) and GUARD′n SHIELD® (B. subtilis, B. licheniformis, B. pumilus, and B. subtilis KLB at a ratio of 3:1:3:1.3 by CFU)) as foliar sprays for the management of Black Sigatoka streak in Hawaii and compare with the grower practice (Manzate Max F (mancozeb), applied as foliar sprays).

In the study, three treatments were assigned separately to one of 3, three-row blocks of banana plants, a Cavendish variety, ‘Williams’. Each block contained approximately 160 production units (i.e., banana mats). The three treatments are specified below.

Treatment I.

Grower Practice (GP) spray formulation: Manzate (1.8 qt. per acre); Superior 70 oil (3 qt. per acre); Latron (3 oz. per acre); and approx. 12 gal. spray applied per acre.

Treatment II.

GUARD′n SHIELD® (GS) treatment spray formulation: 64 oz. Superior 70 oil; 20 mL GUARD′n SHIELD®; 2 oz. Latron spreader/sticker; and 10 gal. water.

Treatment III.

“Prototype” (P) treatment spray formulation: 64 oz. Superior 70 oil; 1 gram per gallon of “Prototype”; 2 oz. Latron spreader/sticker; and 10 gal. water.

Several plants per row at the inception of the trial were tagged in order to calculate the number of newly merged leaves at the end of the trial period. Leaves were tagged with surveyors tape at second leaf below the furled leaf, as these two leaves had not been sprayed with any fungicide previously (a sufficient number of days had elapsed since last spray treatment—these were newly emerged leaves since that date).

The products were applied using a 31″, tractor-mounted air-blast sprayer. Products were mixed in 10 gal tap water to achieve the specified concentration. Powdered or granular products were placed on the screen at the mouth of the spray tank and sprayed into the tank until dissolved. Products were agitated by the tank agitator for 10 minutes before sprays were applied. The land area for each treatment equaled ⅓ acre and approx. 4 gallons of spray was used on each treatment area.

Disease assessments were made visually according to the international disease assessment scale for Black Sigatoka. In this study, disease assessment began on the youngest leaf (i.e., the first fully opened leaf at the top of the plant and moved down the plant to the leaf that had been tagged with surveyors' tape). Each leaf was given an assessment number of 0 (no disease), 1, 2, 3, 4, 5 or 6 (>50% leaf area diseased). Numbers were transformed to percent disease by assigning the midpoint value for each category (0-6) to the leaf's disease assessment. For example, a leaf with an assessment value of 5 received a percent disease value of 42% (the midpoint between 34 and 50%).

Data were analyzed by analysis of variance (ANOVA) using he open-source software SOFA Statistics. The results and summary ANOVA tables appear below. Mean separation was performed by independent t-tests.

Key to the following analytical output tables: Gp=Grower practice; Gs=GUARD'n SHIELD®; P=Prototype; Sumdis=disease severity (%), summed for 8 leaves; YLS=youngest leaf spotted.

Disease severity (percentage of leaf area diseases, Black Sigatoka): ANOVA. The value of Disease severity was calculated for each plant by summing the severity values for each of the 8 leaves assessed for a plant (designated Sumdis in the data spreadsheet). These values were then submitted to the ANOVA procedure using the open-source software SOFA Statistics).

The effect of treatment on disease severity was significant (P<0.001).

Results of ANOVA test of average Sumdis for Trt groups from “Gp” to “P” are shown in Tables 1 and 2.

TABLE 1
Analysis of variance table

| | Sum of | | Mean Sum | | |
|---|---|---|---|---|---|
| Source | Squares | df | of Square | F | p |
| Between | 26803.047 | 2 | 13401.523 | 10.849 | <0.001 |
| | | | | | (7.616e−5) |
| Within | 88941.840 | 72 | 1235.303 | | |

In Table 1, O'Brien's test for homogeneity of variance: 2.116e-3.

TABLE 2
Group summary details

| | | | CI | Standard | | | | | p |
|---|---|---|---|---|---|---|---|---|---|
| Group | N | Mean | 95% | Deviation | Min | Max | Kurtosis | Skew | abnormal |
| Gp | 25 | 64.54 | 45.036- | 49.755 | 5.5 | 155.0 | −1.058 | 0.427 | 0.1852 |
| | | | 84.044 | | | | | | |
| Gs | 25 | 25.02 | 15.510- | 24.261 | 3.0 | 109.0 | 3.707 | 1.720 | <0.001 |
| | | | 34.530 | | | | | | (4.752e−5) |
| P | 25 | 23.88 | 13.950- | 25.332 | 1.0 | 88.0 | 0.200 | 1.169 | 0.03034 |
| | | | 33.810 | | | | | | |

Disease severity was significantly greater in the Grower Practice treatment.

“Prototype” did not differ significantly from GUARD′n SHIELD®.

Results of Independent Samples t-test of average “Sumdis” for Trt groups “Gs” vs “P”: p value: 0.8716; t statistic: 0.163; degrees of freedom (df): 48; O'Brien's test for homogeneity of variance: 0.8814.

Results of Independent Samples t-test of average “Sumdis” for Trt groups “Gp” vs “Gs”: p value: <0.001; t statistic: 3.57; degrees of freedom: 48; O'Brien's test for homogeneity of variance: 0.002.

There was a significant effect of treatment on YLS (p<0.001).

Results of ANOVA test of average YLS for Trt groups from “Gp” to “P” are shown in Tables 3 and 4.

TABLE 3
Analysis of variance table

| | Sum of | | Mean Sum | | |
|---|---|---|---|---|---|
| Source | Square | df | of Square | F | p |
| Between | 12.187 | 2 | 6.093 | 11.743 | <0.001 |
| | | | | | (3.856e−5) |
| Within | 37.360 | 72 | 0.519 | | |

In Table 3, O'Brien's test for homogeneity of variance: 0.5347.

TABLE 4
Group summary details

| | | | CI | Standard | | | | | p |
|---|---|---|---|---|---|---|---|---|---|
| Group | N | Mean | 95% | deviation | Min | Max | Kurtosis | Skew | abnormal |
| Gp | 25 | 4.88 | 4.619- | 0.666 | 4.0 | 7.0 | 2.604 | 0.990 | 4.055e−3 |
| | | | 5.141 | | | | | | |
| Gs | 25 | 5.16 | 4.943- | 0.554 | 4.0 | 6.0 | 0.055 | 0.091 | 0.8038 |
| | | | 5.377 | | | | | | |
| P | 25 | 5.84 | 5.488- | 0.898 | 5.0 | 8.0 | −0.579 | 0.669 | 0.2795 |
| | | | 6.192 | | | | | | |

Grower Practice and GUARD′n SHIELD® had significantly younger leaves with spots than did “Prototype.” Grower Practice did not differ significantly from GUARD′n SHIELD®.

Results of Independent Samples t-test of average “YLS” for Trt groups “Gp” vs “P”: p value: <0.001 (8.509e-5); t statistic: −4.293; Degrees of freedom: 48; and O'Brien's test for homogeneity of variance: 0.2040.

Results of Independent Samples t-test of average “YLS” for Trt groups “Gp” vs “Gs”: p value: 0.1125; t statistic: −1.617; Degrees of freedom: 48; and O'Brien's test for homogeneity of variance: 0.5347.

Disease severity was significantly greater for the Grower Practice than either GUARD′n SHIELD® or the Prototype. The Prototype showed overall lower average disease incidence. The Prototype showed a significant advantage when it comes to controlling Black Sigatoka on young banana tree leaves.

### Example 2. Varying the Ratio of Bacillus subtilis 34 KLB Over Bacillus amyloliquefaciens

Experimental protocol: (1) Streak and grow Bacillus subtilis 34 KLB and Bacillus amyloliquefaciens on trypticase soy agar (TSA) medium for 4-days. (2) Ratio derivation and procedure: (a) Using sterile technique, place full 5 loops of each bacillus in microcentrifuge tubes containing 4 mL sterile distilled water. Vortex each for 1 minute; (b) Create ratios in microcentrifuge tubes by pipetting aliquots of 200 microliters from each of the 4 mL suspension for B. subtilis 34 KLB and B. amyloliquefaciens (example: a 1:5 ratio was achieved by combining 200 microliters of 34 KLB and 1000 microliters of B. amyloliquefaciens). Repeat aliquot samples as needed to acquire sufficient volume for each ratio in the experiment; (c) Spot 20 microliters of each ratio onto a position onto 10% V8 juice agar surface. There were three plates (=reps) for each ratio; (d) Spot a 2 mm×2 mm square piece of Collectotrichum musae (fungus responsible for crown rot on bananas) on the opposing side of the Petri plate (3 plates each); and (e) After 10 days of growth at 25° C., measure inhibition zones by hand.

Table 5 shows the results. Mixtures appear to perform better than either Bacillus subtilis 34 KLB or Bacillus amyloliquefaciens.

TABLE 5

| | Clearing |
|---|---|
| Bacteria | Zone |
| 100% B. amyloliquefaciens | 9 mm |
| 100% B. subtilis 34 KLB | 8 mm |
| 1:1 B. subtilis 34 KLB: B. amyloliquefaciens | 19 mm |
| 2:1 B. subtilis 34 KLB: B. amyloliquefaciens | 12 mm |
| 5:1 B. subtilis 34 KLB: B. amyloliquefaciens | 17 mm |
| 10:1 B. subtilis 34 KLB: B. amyloliquefaciens | 20 mm |
| 1:2 B. subtilis 34 KLB: B. amyloliquefaciens | 20 mm |
| 1:5 B. subtilis 34 KLB: B. amyloliquefaciens | 15 mm |
| 1:10 B. subtilis 34 KLB: B. amyloliquefaciens | 18 mm |

### Example 3. Growth Inhibition Assays

The fungi were selected to represent a wide range of taxonomic orders. Many of the fungi were important plant pathogens in Hawaii. Isolations of plant pathogens were done from symptomatic host plant tissues, whereby fungal propagules or plant tissues were transferred first to Petri dishes containing water agar. Subsequently, hyphal tips or spores emerging on the water agar were transferred to a growth medium suitable for each fungal species, with 10% V8 juice agar being the predominant growth medium used. Fungi were identified to genus or species level by morphology and/or DNA sequences. In some cases, several different species of a given fungal genus were isolated and tested for inhibition.

BiOWiSH® Bacteria strains BW34 (B. subtilis), BW283 (B. amyloliquefaciens), and BW14 (Lactobacillus plantarum) were used. These strains were grown and maintained via periodic subcultures on the various growth media (trypticase soy agar (TSA), mannitol salt agar (MSA), nutrient agar (NA)).

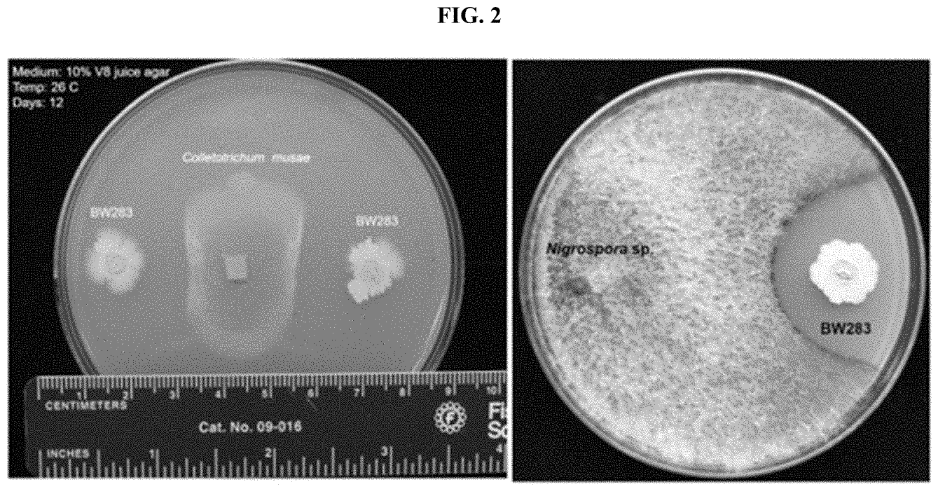

BiOWiSH® bacterial strains were evaluated in Petri dishes for their inhibition of the mycelial growth at room temperature (approx. 22 to 23° C.) of various species of fungi. The BiOWiSH® bacteria were evaluated individually, not in combinations or mixtures. Most of the inhibition trials were conducted in Petri dishes on 10% V8 juice agar, upon which BiOWiSH® bacteria were spotted across from the test organisms (FIG. 2) in replicates of three dishes. In some cases, a BiOWiSH® organism was spotted at the center of the dish and the test organism spotted to the left and right of it, or vice versa. For fast-growing fungi, i.e., fungi capable of growing across the separating distance in 48 hours or less, culture plugs were spotted on the growth medium 3 days after spotting the BiOWiSH® strains. The delayed spotting allowed the circular, inhibitory zones of the BiOWiSH® organisms to become established by radial diffusion of the inhibitory compounds into the growth medium before the approach of fungal mycelium, preventing false negative results. Paired cultures were allowed to incubate until the zones of inhibition were established and visible (for sensitive fungi) or until the BiOWiSH® strain was overgrown by fungal species insensitive to the inhibitory zone. The diameters of the circular, inhibitory zones were measured in millimeters along the radii of the circles surrounding the BiOWiSH® strains and averaged among the three replicates.

Fungal plant pathogens screened for inhibition by BiOWiSH® strains BW34 and BW283 included, but were not limited to: Colletotrichum sp., Cladosporium colocasiae, Pseudocercospora ocimi-basilici, Colletotrichum musae, Mycosphaerella fijiensis, Cercospora ipomoea, Botrytis cinerea, Penicillium sp., Rhizopus sp., Phoma sp., Phytophthora colocasiae, Curvularia sp., Mucor sp., Nigrospora sp., Fusarium sp. (F. roseum), Fusarium oxysporum f sp. niveum, Chalara paradoxa (syn. Thielaviopsis paradoxa), Pestalotia sp., Stemphylium sp., Alternaria solani, Monolinia fructicola, Botrytis sp., Phytophtora palmivora, Phytophthora parasitica, Phytophthora infestans, Fusarium oxysporum f. sp. cubense (Foc).

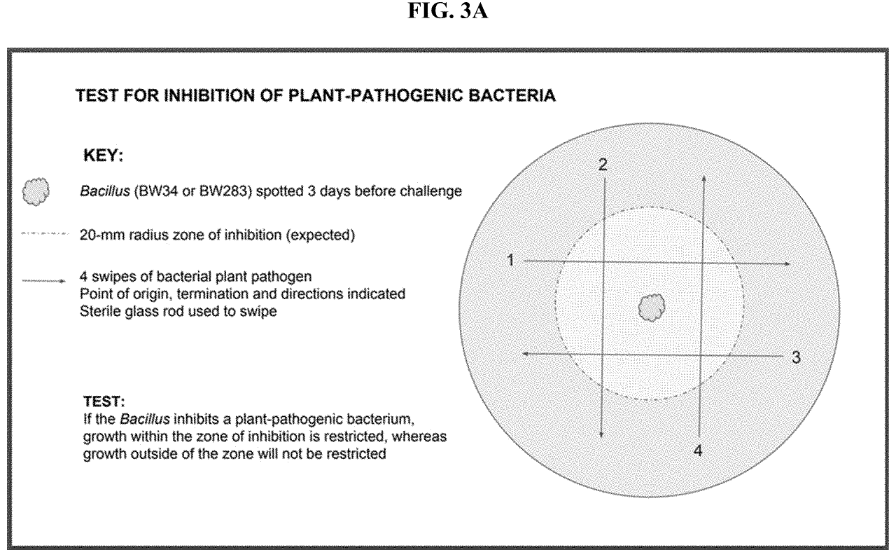

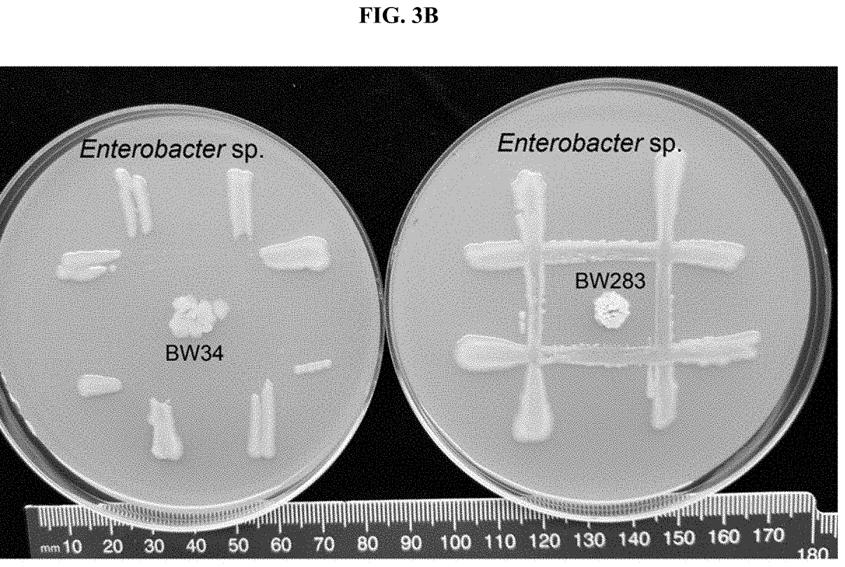

BiOWiSH® bacterial strains were evaluated in Petri dishes for their inhibition of the growth at room temperature (approx. 22 to 23° C.) of several species of bacteria. A BiOWiSH® strain was spotted at the center of the dish, whereas a species of test bacteria was streaked in a square hashtag pattern about the center 3 days later. The intersecting corners of the square hashtag pattern were positioned near the edge of the expected inhibition zone (approx. 20 mm radius from center) from center, whereas the center of each of the four lines of the square were positioned at less than 20 mm from center. Then, after several days of growth, if inhibition was present, the effect was visible as lack of growth within the lines and normal growth beyond the corners of the square hashtag (FIG. 3A and FIG. 3B). Each bacterial species was paired against a BiOWiSH® strain with three replicate Petri dishes.

Bacterial plant pathogens screened for inhibition by BiOWiSH® strains BW34 and BW283: Xanthomonas campestris pv. Campestris, Enterobacter sp., Acidovorax sp. and Xanthomonas axonopodis pv. dieffenbachiae.

TABLE 6
Results from in vitro growth inhibition assays
Plate Inhibition Trials

| | | | | BW |
|---|---|---|---|---|
| Common Name | Species | Source Plant | Effective? | Species |
| Anthracnose | Colletotrichum sp. | Aloe | Yes | BW283, |
| | | | | BW34 |
| Ghost Spot | Cladosporium colocasiae | Taro | Yes | BW283, |
| | | | | BW34 |
| Leaf Spot | Pseudocercospora ocimi- | Basil | Yes (Strong) | BW283, |
| | basilici | | | BW34 |
| Crown Rot, | Colletotrichum musae | Banana | Yes | BW283, |
| Anthracnose | | | | BW34 |
| Black Sigatoka | Mycosphaerella fifiensis | Banana | Yes | BW14, |
| | | | | BW34, |
| | | | | BW283 |
| Cercospora leaf | Cercospora ipomoea | Beach Morning | Yes (Strong) | BW283 |
| spot | | Glory | | |
| Stem Blight | Botrytis cinerea | Fig | Yes (Strong) | BW34, |
| | | | | BW283 |
| Citrus Mold | Penicillium sp | Citrus | Yes (Strong) | BW34, |
| | | | | BW283 |
| Soft Rot | Rhizopus sp | Cannonball Tree | No | BW14, |
| | | | | BW34, |
| | | | | BW283 |
| Branch Canker and | Phoma sp | Milo | Reproductive | BW34, |
| dieback | | | Inhibition | BW283 |
| Leaf Blight | Phytophthora colocasiae | Taro | Slight | BW34, |
| | | | | BW283 |
| Leaf Blight | Curvularia sp | Turfgrass | Yes (Strong) | BW34, |
| | | | | BW283 |
| Fruit Rot | Mucor sp | Breadfruit | Yes | BW34, |
| | | | | BW283 |
| Leaf Blight | Fusarium sp Isolate 1 | Turfgrass | Possibly | BW34, |
| | | | | BW283 |
| Leaf Blight | Nigrospora sp | Turfgrass | Yes (Strong) | BW34, |
| | | | | BW283 |
| | Geotrichum sp | | No | BW283 |
| Wilt | Fusarium oxysporum f sp | Watermelon | Yes | BW34 |
| | niveum | | | |
| Crown Rot | Chalara paradoxa | Banana | Yes | BW34, |
| | (Thielaviopsis paradoxa) | | | BW283 |
| Brown Rot of Fruit | Monilinia fructicola | Nectarine | Yes | BW34, |
| | | | | BW283 |
| Black Rot | Xanthomonas campestris pv. | Cabbage | Yes | BW283 |
| | Campestris | | | |
| Gray mold of fruit | Botrytis sp | Peach | Yes | BW34, |
| | | | | BW283 |
| Black Mold | Alternaria solani | Tomato | Yes | BW34, |
| | | | | BW283 |
| | Stemphyllium sp. | | Yes | BW34 |
| Cigar-end rot | Pestalotia sp | Banana | Yes | BW34, |
| | | | | BW283 |
| Blight | Xanthomonas axonopodis | Anthurium | Yes | BW34, |
| | pv. Dieffenbachiae | | | BW283 |
| Black Rot | Xanthomonas campestris pv. | Cabbage | Yes | BW34, |
| | campestris (Xcc) | | | BW283 |
| Decay | Enterobacter sp | Collard | Yes | BW34 |
| Decay | Acidovorax sp | Lettuce | Yes | BW34 |
| Fusarium Wilt | Fusarium oxysporum f. sp. | Banana— | Yes | BW283, |
| (Panama Disease) | cubense race 1 | Hawaiian | | BW34 |
| | | Variegated | | |
| Muscadine disease | Beauveria bassiana | Banana Aphid | Yes | BW34 |
| of arthropods | | | | |
| Late Blight | Phytophthora infestans | Tomato | Yes (Strong) | BW34 |
| Fruit Blight | Phytophthora palmivora | Cocoa | No | BW34, |
| | | | | BW283 |

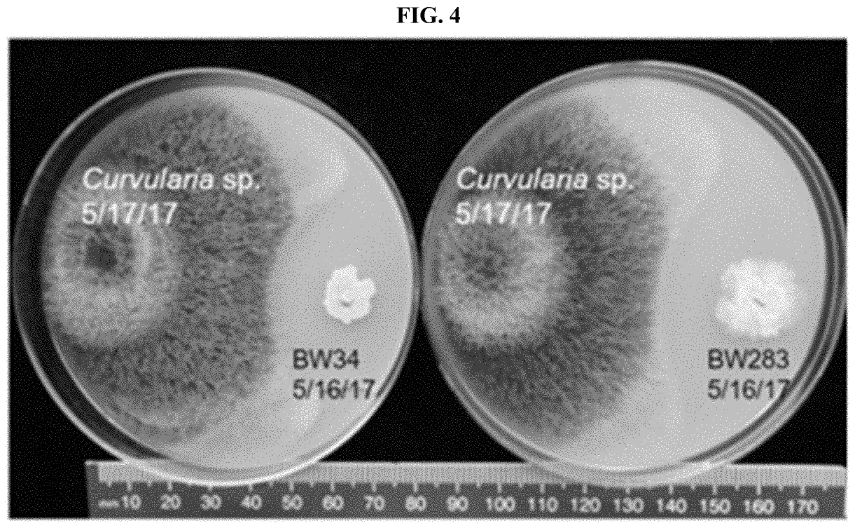

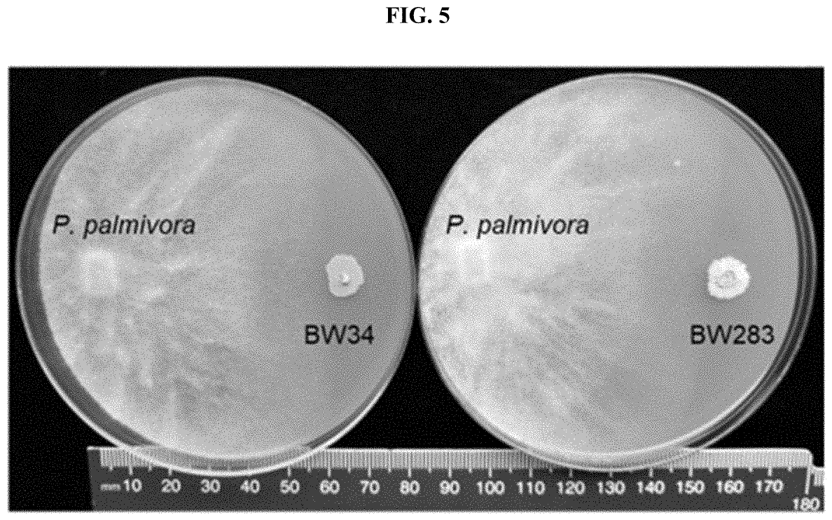

FIG. 4 shows examples of strong inhibition of fungal species Curvularia sp. by BW34 and BW283. FIG. 5 shows examples of no inhibition of fungal species Phytopthora palmivora by BW34 and BW283.

### Example 4. In Vitro Growth Screening Assays

Novel approaches to managing soilborne diseases of strawberry are in need due to the phase-out and increased regulation of commonly used soil fumigants in California such as methyl bromide and chloropicrin. Microbiologically-based intervention strategies are desirable due to their minimal adverse environmental impact. The objective of this study was to evaluate nineteen bacterial strains owned by BiOWiSH Technologies for their ability to suppress the strawberry pathogens Botrytis cinerea, Fusarium oxysporum f.sp. fragariae, Macrophomina phaseolina and Verticillium dahliae in vitro.

Prior to use in plant-pathogen inhibition screening, bacterial isolates were taken out of long-term storage and streaked with a sterile loop on either potato dextrose agar (PDA) or De Man, Rogosa and Sharpe (MRS) agar, depending upon the required growth medium. Plates were parafilmed and incubated upside-down for 18 to 24 hours at 35° C. After incubation, a 10 μL sterile loop was used to transfer each bacterium into separate conical tubes containing 10 mL of either trypticase soy broth (TSB) agar or MRS broth, and the broth containing bacteria was incubated for 18 to 24 hours at 35° C. These cultures were then centrifuged at 3000 rpm for 15 minutes at 25° C. Centrifugation was repeated for any bacteria that did not form a sufficient pellet in the conical tube. The supernatant in each tube was discarded and the pellet was re-suspended in 10 mL of previously autoclaved 0.1% peptone in deionized water. For the plant-pathogen inhibition screening, this solution of bacteria suspended in 0.1% peptone was plated within 6 hours.

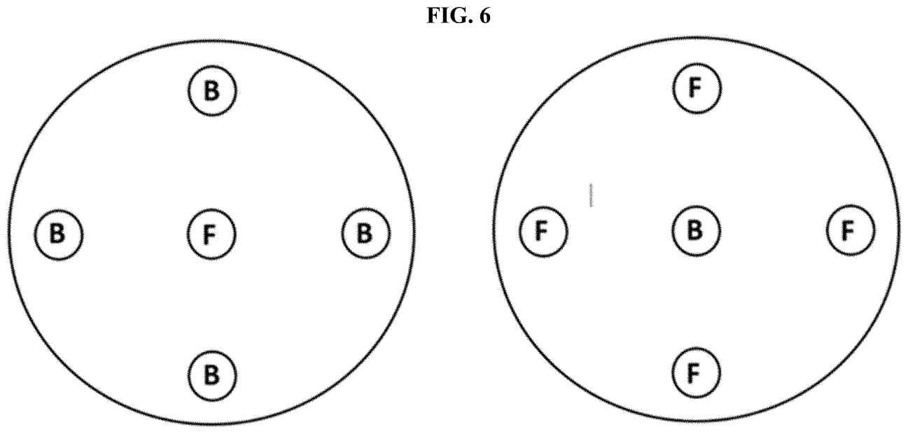

There were two designs for the plant-pathogen inhibition screening that differed in their location of the fungal plant pathogen and bacterial antagonist (FIG. 6).

There were three replicates of each method for each unique combination of plant pathogen and bacterium. Each petri dish contained one plant pathogen, either Fusarium oxysporum f. sp. fragariae, Verticillium dahliae, Macrophomina phaseolina, or Botrytis cinerea. In a laminar flow hood, 6 mm mycelial plugs of each plant pathogen were placed in the proper location of the corresponding petri dish containing either MRS agar or PDA, depending on the growth requirement of the bacterium. Controls of the plant pathogen on both media were used to account for any difference in growth rate of the plant pathogen that may have been due to the difference in growth medium. There were three control plates for each method, and control plates included both MRS agar and PDA; control plates contained the plant pathogen alone, without the bacterial antagonist. There were also 3 plates of both PDA and MRS agar that neither the plant pathogen nor the bacterial isolated were plated on to ensure no contaminants were introduced through at any process during screening. After vortexing, 5 μL of each bacterial isolate in 0.1% peptone were pipetted on each corresponding petri dish that contained the 6 mm mycelial plug(s) placed mycelial side down earlier that day. Plates were moved into clear plastic boxes and stored in an incubator kept at room temperature (16.3 to 23.9° C.) for the duration of the experiment.

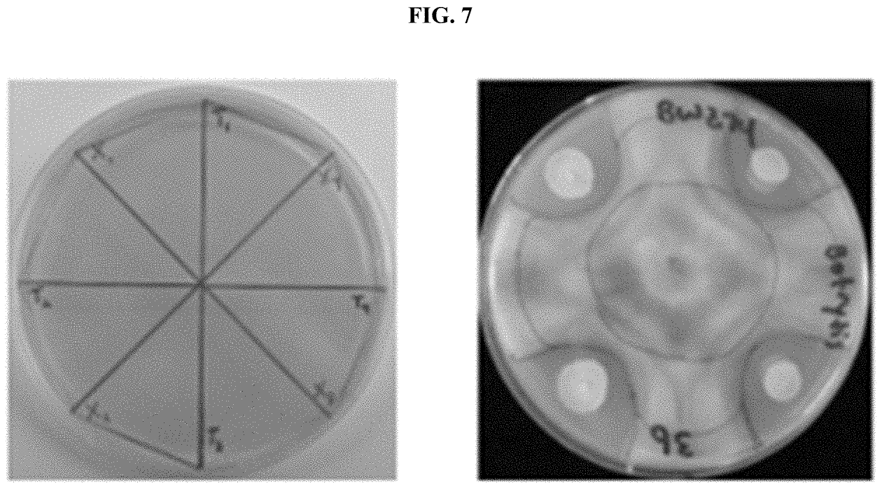

Appressed mycelial growth was traced directly on the underside of petri dishes with a colored sharpie on each day data were collected. The growth rate of each fungus determined which day data were collected and the duration the in vitro inhibition screening lasted. For instance, M. phaseolina grows quickly compared to other the other fungi examined, so inhibition data were collected every day and the inhibition screening lasted the least amount of time, whereas V. dahliae grows slower in comparison so data were taken at least every three days and the inhibition screening lasted the longest. At the end of the experiment, a template was used to divide each petri dish into eight equal parts (FIG. 7). The lines of the template were placed over the bacterial antagonist, and the growth (mm) of each fungus was measured along the line for each day growth had previously been traced.

The average mycelial growth (mm) for each unique combination of fungal plant pathogen and antagonistic bacterium was calculated for each day data were collected. Once the experiment had concluded, the Area Under the Growth Progress Curve (AUGPC) was calculated using the following equation:

$$AUGPC = \sum \frac{Growth T 1 + Growth T 2}{2} \times ( T 2 - T 1 )$$

where T1 is the last day assessed and T2 is the current day being assessed. Once the AUGPC for each unique combination of fungal plant pathogen and bacterium had been determined, percent fungal inhibition was calculated using the following equation:

$$\frac{\begin{matrix}( Control Fungus AUGPC ) - \\ ( AUGPC of Fungus Containing Bacterium )\end{matrix}}{( AUGPC Control Fungus )} \times 100 \%$$

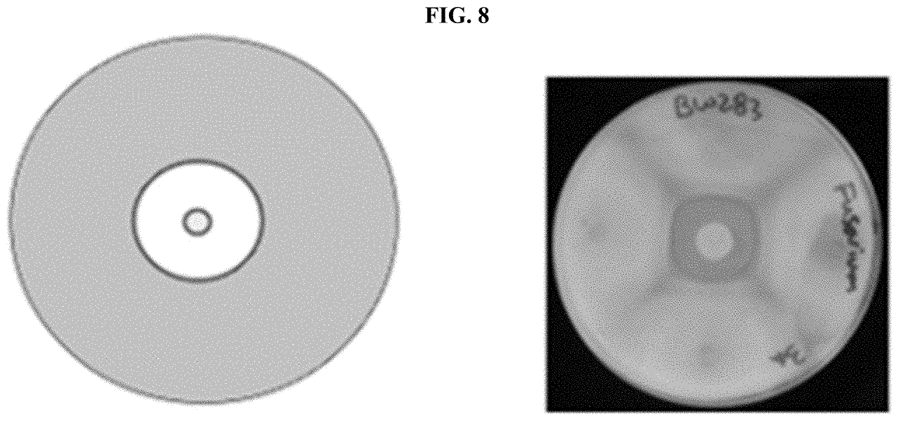

The zone of fungal inhibition produced by each bacterium was determined on the last day of inhibition screening for each particular fungus (FIG. 8). Control plates, with each fungus introduced around the perimeter of the petri dish and no bacterial antagonist in the center, were used to verify somatic compatibility and to ensure that the fungus would indeed cover the entirety of the plate without any bacterium present. A template with two perpendicular lines that intersected at the center of the Petri dish was used to measure the diameter (mm) of the zone of inhibition. In plates that lacked a zone of inhibition, its absence was recorded. The control plates of V. dahliae showed that the fungus does not have somatic compatibility in its vegetative state (mycelium), so it was not included in the zone of inhibition experiment.

Bacillus amyloliquefaciens provided the greatest inhibition of B. cinerea overall; BW274, BW283, and BW280 inhibited fungal growth by an average of 45.3%, 44.1% and 41.8%, respectively. Three B. subtilis strains, BW273, BW281 and BW284 also inhibited fungal growth by a significant amount when compared to the control, although to lesser degree than B. amyloliquefaciens. All other bacteria did not inhibit mycelial growth of B. cinerea by a significant amount (Table 7).

TABLE 7
In vitro efficacy of four Bacillus species (15 strains total) against Botrytis cinerea.

| | | | AUGPC^{a} | | |
|---|---|---|---|---|---|
| Bacteria | | | | Tukey Pairwise | Inhibition |
| Species | Strain | Fungus | Mean | Comparison^{b} | (%)^{c} |
| Bacillus pumilus | BW285 | B. cinerea | 283.1 | A | −1.5 |
| Bacillus pumilus | BW275 | B. cinerea | 282.0 | A | −1.1 |
| Bacillus licheniformis | BW277 | B. cinerea | 279.4 | A | −0.2 |
| Bacillus licheniformis | BW286 | B. cinerea | 279.3 | A | −0.1 |
| Bacillus pumilus | BW279 | B. cinerea | 279.1 | A | 0.0 |
| Control PDA | | B. cinerea | 279.0 | A | 0.0 |
| Bacillus subtilis | BW34 | B. cinerea | 277.4 | A | 0.6 |
| Bacillus licheniformis | BW278 | B. cinerea | 275.3 | A | 1.3 |
| Bacillus licheniformis | BW276 | B. cinerea | 270.2 | A | 3.2 |
| Bacillus subtilis | BW282 | B. cinerea | 265.6 | A | 4.8 |
| Bacillus subtilis | BW284 | B. cinerea | 186.5 | B | 33.1 |
| Bacillus subtilis | BW281 | B. cinerea | 169.8 | BC | 39.1 |
| Bacillus subtilis mojavensis | BW273 | B. cinerea | 168.7 | BC | 39.5 |
| Bacillus amyloliquefaciens | BW280 | B. cinerea | 162.3 | C | 41.8 |
| Bacillus amyloliquefaciens | BW283 | B. cinerea | 156.0 | C | 44.1 |
| Bacillus amyloliquefaciens | BW274 | B. cinerea | 152.7 | C | 45.3 |

^{a}Area Under the Growth Progress Curve;
^{b} Grouping information generated using the Tukey Method and 99% confidence. Means that do not share a letter are significantly different;
^{c}Percent inhibition relative to the control.

All species of Bacillus that inhibited B. cinerea by a significant amount when examining AUGPC and percent inhibition had also established a clear zone of inhibition at the end of the experiment (Table 8). All other strains of bacteria did not have any zone of inhibition at the end of the experiment.

TABLE 8
In vitro zone of inhibition caused by bacterial antagonists against
Botrytis cinerea.

| Bacteria | | | Zone of Inhibition |
|---|---|---|---|
| Species | Strain | Fungus | (mm)^{a} |
| Bacillus subtilis | BW284 | B. cinerea | 8.2 |
| Bacillus subtilis mojavensis | BW273 | B. cinerea | 9.8 |
| Bacillus subtilis | BW281 | B. cinerea | 17.7 |
| Bacillus amyloliquefaciens | BW280 | B. cinerea | 18.5 |
| Bacillus amyloliquefaciens | BW274 | B. cinerea | 18.8 |
| Bacillus amyloliquefaciens | BW283 | B. cinerea | 19 |

^{a}Diameter of the clearing around each bacterium on the last day of the experiment (day 9).

Bacillus amyloliquefaciens provided the greatest inhibition of F. oxysporum f. sp. fragariae overall; BW274, BW280 and BW283 inhibited growth of the fungus by an average of 49.3%, 48.2% and 45.9%, respectively. Two B. subtilis strains, BW281 and BW284, inhibited fungal growth by a significant amount, although BW281 was almost twice as effective as BW284. BW278, a strain of B. licheniformis, also inhibited growth of the fungus by a significant amount. All other bacteria did not inhibit growth of F. oxysporum f. sp. fragariae by a significant amount (Table 9).

TABLE 9
In vitro efficacy of four Bacillus species (15 strains total) against Fusarium
oxysporum f sp. fragariae.

| | | | AUGPC^{a} | | |
|---|---|---|---|---|---|
| Bacteria | | | | Tukey Pairwise | Inhibition |
| Species | Strain | Fungus | Mean | Comparison^{b} | (%)^{c} |
| Bacillus pumilus | BW279 | F. oxysporum f. sp. f. | 446.3 | A | −1.7 |
| Bacillus pumilus | BW275 | F. oxysporum f. sp. f. | 443.6 | AB | −1.1 |
| Bacillus pumilus | BW285 | F. oxysporum f. sp. f. | 441.7 | ABC | −0.6 |
| Control PDA | | F. oxysporum f. sp. f. | 438.8 | ABC | 0.0 |
| Bacillus subtilis | BW34 | F. oxysporum f. sp. f. | 436.3 | ABC | 0.6 |
| Bacillus subtilis | BW282 | F. oxysporum f. sp. f. | 433.6 | ABC | 1.2 |
| Bacillus licheniformis | BW277 | F. oxysporum f. sp. f. | 427.4 | ABC | 2.6 |
| Bacillus licheniformis | BW276 | F. oxysporum f. sp. f. | 425.9 | ABC | 2.9 |
| Bacillus subtilis | BW273 | F. oxysporum f. sp. f. | 416.3 | BCD | 5.1 |
| mojavensis | | | | | |
| Bacillus licheniformis | BW286 | F. oxysporum f. sp. f. | 412.9 | CD | 5.9 |
| Bacillus licheniformis | BW278 | F. oxysporum f. sp. f. | 389.8 | D | 11.2 |
| Bacillus subtilis | BW284 | F. oxysporum f. sp. f. | 354.1 | E | 19.3 |
| Bacillus subtilis | BW281 | F. oxysporum f. sp. f. | 249.5 | F | 43.1 |
| Bacillus | BW283 | F. oxysporum f. sp. f. | 237.3 | F | 45.9 |
| amyloliquefaciens | | | | | |
| Bacillus | BW280 | F. oxysporum f. sp. f. | 227.4 | F | 48.2 |
| amyloliquefaciens | | | | | |
| Bacillus | BW274 | F. oxysporum f. sp. f. | 222.7 | F | 49.3 |
| amyloliquefaciens | | | | | |

^{a}Area Under the Growth Progress Curve;
^{b}Grouping information generated using the Tukey Method and 99% confidence. Means that do not share a letter are significantly different;
^{c}Percent inhibition relative to the control.

All strains of B. amyloliquefaciens (BW274, BW280, and BW283) and one strain of B. subtilis (BW281) had produced a zone of inhibition at the end of the experiment (Table 10).

TABLE 10
In vitro zone of inhibition caused by bacterial antagonists against
Fusarium oxysporum f. sp. fragariae.

| | | | Zone of |
|---|---|---|---|
| Bacteria | | | Inhibition |
| Species | Strain | Fungus | (mm)^{a} |
| Bacillus subtilis | BW281 | F. oxysporum f. sp. f. | 13.5 |
| Bacillus amyloliquefaciens | BW283 | F. oxysporum f. sp. f. | 20.3 |
| Bacillus amyloliquefaciens | BW280 | F. oxysporum f. sp. f. | 24 |
| Bacillus amyloliquefaciens | BW274 | F. oxysporum f. sp. f. | 24.2 |

^{a}Diameter of the clearing around each bacterium on the last day of the experiment (day 16).

Bacillus amyloliquefaciens provided the greatest inhibition of M. phaseolina overall; BW283, BW274 and BW280 inhibited radial growth of the fungus by an average of 48.3%, 40.1% and 39.9%, respectively. Three strains of B. subtilis (BW281, BW284 and BW273) also inhibited growth of the fungus significantly, although this amount was less than that of all B. amyloliquefaciens strains examined. All other bacteria examined did not inhibit mycelial growth of M. phaseolina by a significant amount (Table 11).

TABLE 11
In vitro efficacy of four Bacillus species (15 strains total) against
Macrophomina phaseolina.

| | | | AUGPC^{a} | | |
|---|---|---|---|---|---|
| | | | | Tukey | |
| Bacteria | | | | Pairwise | Inhibition |
| Species | Strain | Fungus | Mean | Comparison^{b} | (%)^{c} |
| Bacillus licheniformis | BW286 | M. phaseolina | 150.5 | A | −5.6 |
| Bacillus pumilus | BW275 | M. phaseolina | 146.7 | AB | −2.9 |
| Bacillus pumilus | BW279 | M. phaseolina | 144.2 | ABC | −1.2 |
| Bacillus pumilus | BW285 | M. phaseolina | 143.3 | ABC | −0.5 |
| Control PDA | Control | M. phaseolina | 142.5 | ABC | 0.0 |
| | PDA | | | | |
| Bacillus subtilis | BW34 | M. phaseolina | 134.3 | ABC | 5.8 |
| Bacillus subtilis | BW282 | M. phaseolina | 128.9 | ABC | 9.5 |
| Bacillus licheniformis | BW278 | M. phaseolina | 124.9 | BC | 12.3 |
| Bacillus licheniformis | BW277 | M. phaseolina | 124.4 | BC | 12.7 |
| Bacillus licheniformis | BW276 | M. phaseolina | 121.7 | C | 14.6 |
| Bacillus subtilis mojavensis | BW273 | M. phaseolina | 98.0 | D | 31.2 |
| Bacillus subtilis | BW284 | M. phaseolina | 88.2 | DE | 38.1 |
| Bacillus subtilis | BW281 | M. phaseolina | 85.8 | DE | 39.8 |
| Bacillus amyloliquefaciens | BW280 | M. phaseolina | 85.7 | DE | 39.9 |
| Bacillus amyloliquefaciens | BW274 | M. phaseolina | 85.4 | DE | 40.1 |
| Bacillus amyloliquefaciens | BW283 | M. phaseolina | 73.6 | E | 48.3 |

^{a}Area Under the Growth Progress Curve;
^{b}Grouping information generated using the Tukey Method and 99% confidence. Means that do not share a letter are significantly different;
^{c}Percent inhibition relative to the control.

All species of Bacillus that inhibited M. phaseolina by a significant amount when examining AUGPC and percent inhibition had also established a clear zone of inhibition at the end of the experiment (Table 12). All other strains of bacteria did not have any zone of inhibition at the end of the experiment.

TABLE 12
In vitro zone of inhibition caused by bacterial antagonists against
Fusarium oxysporum f sp. fragariae.

| Bacteria | | | Zone of Inhibition |
|---|---|---|---|
| Species | Strain | Fungus | (mm)^{a} |
| Bacillus subtilis mojavensis | BW273 | M. phaseolina | 14.7 |
| Bacillus subtilis | BW284 | M. phaseolina | 16.3 |
| Bacillus amyloliquefaciens | BW274 | M. phaseolina | 24.8 |
| Bacillus subtilis | BW281 | M. phaseolina | 25.3 |
| Bacillus amyloliquefaciens | BW280 | M. phaseolina | 25.8 |
| Bacillus amyloliquefaciens | BW283 | M. phaseolina | 25.8 |

^{a}Diameter of the clearing around each bacterium on the last day of the experiment (day 6).

With the exception of BW285, all strains of Bacillus examined inhibited radial mycelial growth of V. dahliae by a significant amount when compared to the control (Table 13).

TABLE 13
In vitro efficacy of four Bacillus species (15 strains total) against Verticillium dahliae.

| | | | AUGPC^{a} | | |
|---|---|---|---|---|---|
| Bacteria | | | | Tukey Pairwise | Inhibition |
| Species | Strain | Fungus | Mean | Comparison^{b} | (%)^{c} |
| Control PDA | | V. dahliae | 765.5 | A | 0.0 |
| Bacillus pumilus | BW285 | V. dahliae | 677.9 | AB | 11.4 |
| Bacillus pumilus | BW279 | V. dahliae | 669.4 | BC | 12.6 |
| Bacillus pumilus | BW275 | V. dahliae | 661.7 | BC | 13.6 |
| Bacillus subtilis | BW282 | V. dahliae | 620.8 | BC | 18.9 |
| Bacillus licheniformis | BW277 | V. dahliae | 595.8 | BC | 22.2 |
| Bacillus subtilis | BW34 | V. dahliae | 578.5 | C | 24.4 |
| Bacillus licheniformis | BW278 | V. dahliae | 481.8 | D | 37.1 |
| Bacillus licheniformis | BW276 | V. dahliae | 478.9 | D | 37.4 |
| Bacillus licheniformis | BW286 | V. dahliae | 469.5 | D | 38.7 |
| Bacillus subtilis mojavensis | BW273 | V. dahliae | 466.0 | D | 39.1 |
| Bacillus subtilis | BW284 | V. dahliae | 433.3 | D | 43.4 |
| Bacillus amyloliquefaciens | BW283 | V. dahliae | 309.0 | E | 59.6 |
| Bacillus amyloliquefaciens | BW280 | V. dahliae | 306.8 | E | 59.9 |
| Bacillus amyloliquefaciens | BW274 | V. dahliae | 299.9 | E | 60.8 |
| Bacillus subtilis | BW281 | V. dahliae | 283.2 | E | 63.0 |

^{a}Area Under the Growth Progress Curve;
^{b}Grouping information generated using the Tukey Method and 99% confidence. Means that do not share a letter are significantly different;
^{c}Percent inhibition relative to the control.

This portion of the experiment was not conducted due to vegetative incompatibility of V. dahliae.

A subset of the most effective bacterial strains in vitro was selected for in-planta experiments (Examples 5 and 6).

### Example 5. In-Planta Greenhouse Evaluations of BiOWiSH® and Commercial Strains of Bacteria for Suppression of Macrophomina Crown Rot and Verticillium Wilt

Novel approaches to managing soilborne diseases of strawberry are in need due to the phase-out and increased regulation of commonly used soil fumigants in California such as methyl bromide and chloropicrin. Microbiologically-based intervention strategies are desirable due to their minimal adverse environmental impact. The objective of this study was to evaluate five bacterial strains owned by BiOWiSH Technologies and two commercial products for their ability to suppress crown rot and wilt of strawberry caused by the soilborne fungi Macrophomina phaseolina and Verticillium dahliae under greenhouse conditions.

M. phaseolina and V. dahliae inoculum containing microsclerotia was created using a previously described method. Isolates Mp8, Mp21, Mp22 and Vd1, Vd3, Vd7, Vd20 from the Ivors lab culture collection were used to produce the Macrophomina and Verticillium inoculum respectively. Isolates were plated on PDA, and after three days, a few 5 mm agar plugs of each culture were aseptically added to a 500 mL bottle containing 250 mL of a sterile sand-cornmeal medium (V:V ratio of 1.1 sand:0.4 cornmeal:0.4 deionized water). The inoculum was incubated in the dark at 25° C. and shaken every 1 to 2 days to promote uniform distribution of the fungus in the mixture. After three weeks of incubation, a dissecting microscope was used to verify the cornmeal had been fully colonized by the fungus. The inoculum was then poured onto flat metal trays, all isolates were mixed, and allowed to dry in the dark at room temperature for roughly three weeks.

Ten grams of the inoculum was added to trade one-gallon pots containing roughly 565 grams of potting substrate. In an attempt to uniformly distribute the inoculum throughout the potting mix, both the inoculum and potting substrate were added to a plastic bag, shaken, then placed back into the pots. For enumeration of the inoculum, a mortar and pestle was used to grind the inoculum, which was then passed through a 0.180 mm sieve. This ground inoculum was suspended in sterile water, serially diluted, and plated onto a semi-selective medium (6 plates for each dilution). Plates were stored in the dark at room temperature and enumerated after five days.

To determine the number of colony forming units (CFU) applied, the spread plate method was used. Overnight cultures were serially diluted in sterile deionized water and plated onto either trypticase soy agar (TSA) or De Man, Rogosa and Sharpe (MRS) agar, depending on the required growth medium. All bacteria were applied in the greenhouse on the same day the spread plating occurred. Plates were incubated overnight and CFUs were counted the next day.

For the Macrophomina trial, the cultivar San Andreas was used; for the Verticillium trial, the cultivar Portola was used. Plants were grown in trade one-gallon pots filled with Miracle-Gro Potting Mix.

A total of seven strains of bacteria were evaluated for their ability to inhibit crown rot of strawberry caused by Macrophomina phaseolina (Table 14) and Verticillium wilt caused by Verticillium dahliae (Table 15).

Table 14. Bacteria used in the in-planta evaluation of bacterial stains for suppression of strawberry crown rot caused by Macrophomina phaseolina.

| Company | Product | Species | Strain |
|---|---|---|---|
| BiOWiSH | Not | Bacillus licheniformis | BW276 |
| Technologies | Commercially | Pediococcus pentosaceus | BW13 |
| | Available | Lactobacillus plantarum | BW14 |
| | | Bacillus subtilis | BW281 |
| | | Bacillus amyloliquefaciens | BW283 |
| Bayer | Serenade ASO | Bacillus subtilis | QST 713 |
| Certis USA | Double Nickel | Bacillus amyloliquefaciens | D747 |
| | LC | | |

TABLE 15
Bacteria used in the in-planta evaluation of bacterial stains for
suppression of strawberry wilt caused by Verticillium dahliae.

| Company | Product | Species | Strain |
|---|---|---|---|
| BiOWiSH | Not | Bacillus licheniformis | BW276 |
| Technologies | Commercially | Pediococcus acidilactici | BW12 |
| | Available | Lactobacillus plantarum | BW14 |
| | | Bacillus subtilis | BW281 |
| | | Bacillus amyloliquefaciens | BW283 |
| Bayer | Serenade ASO | Bacillus subtilis | QST 713 |
| Certis USA | Double Nickel | Bacillus amyloliquefaciens | D747 |
| | LC | | |

Each strain was evaluated using four different treatment applications (Table 16).

TABLE 16
Four different treatment applications were evaluated
during the in-planta trial.

| Treatment | Application method |
|---|---|
| 1 | Root Dip on Day 0, Drench on Day 8 |
| 2 | Drench on Day 0, Drench on Day 8 |
| 3 | Root Dip on Day 0, Drench on Day 8, Drench on Day 19 |
| 4 | Root Dip on Day 0, Drench on Day 8, Drench on Day 19, |
| | Drench on Day 29 |

These applications varied by the total number and type of initial application (root dip vs. drench). All subsequent applications after Day 0 were soil drenches. Soil drenches were applied as 450 mL of bacterial suspension per pot; final strain concentrations are reported (Table 16). For experimental controls, deionized water alone was applied, either as a root dip or a drench on Day 0, and also at each time throughout the experiment that an application took place. There were also control plants that were not inoculated with the pathogen and were never treated with any bacteria. Each unique combination of application method and bacterial strain, as well as all controls, was applied on 6 plant replicates.

For every root dip application (Treatment 1, 3, and 4), roots were dipped in a bacterial suspension of 107 CFU/mL for 5 minutes and planted immediately. For Treatment 2, the soil was drenched on Day 0 and plants were planted two days later. Every application after Day 0 was a soil drench (Table 20). After all plants were planted, the pots were distributed randomly by rep on the greenhouse bench.

To determine whether M. phaseolina or V. dahliae was infecting plants, the first two plants from each treatment to die (i.e. exhibit 100% wilting/necrosis) were plated on semi-selective media. Crown pieces were excised, surface disinfested in sodium hypochlorite, and added to 2 plates containing acidified potato dextrose agar (APDA) and 1 plate containing RB media for Macrophomina or 2 plates containing NP-10 media for Verticillium. Each plate received four crown pieces. Later, plates were examined for the presence of either pathogen.

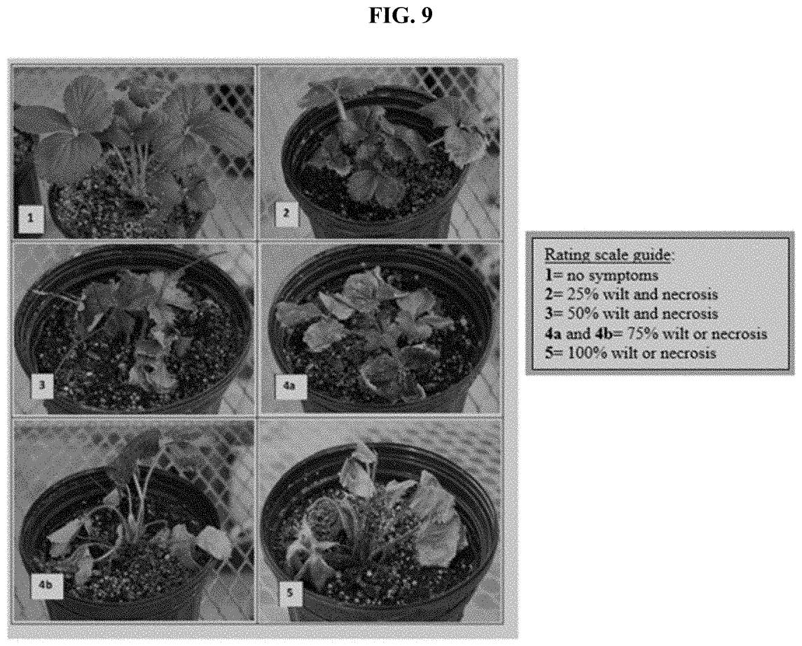

Disease assessments were performed every seven days beginning on Day 23 and ending on Day 107. Disease development was assessed using a rating scale as shown in FIG. 9.

Ratings were converted to percent disease (1=0%, 2=25%, 3=50%, 4=75%, 5=100% disease), then used to calculate the Area Under Disease Progress Curve (AUDPC) for each plant. Analysis of Variance was used to determine differences between bacterial strains within treatments with a p-value of 0.05. Separate analyses were performed for BiOWiSH® strains and commercial products.

Based upon enumeration of fungal colonies on the semi-selective medium (n=6), it was determined that the M. phaseolina inoculated pots contained a final concentration of 2,539 CFU per gram of potting substrate in each pot, and the V. dahliae inoculated pots contained a final concentration of 200 CFU per gram of potting substrate in each pot.

All BiOWiSH® strains were enumerated using the spread plate method and applied in the greenhouse on the same day that plating occurred (Table 17).

TABLE 17
Final CFU/mL of BiOWiSH ® bacteria applied in the greenhouse after
dilution of overnight cultures in deionized water.

| | Macrophomina | | Verticillium | |
|---|---|---|---|---|
| | trial Strain | | trial Strain | |
| Application day | CFU/mL applied | | CFU/mL applied | |
| 0 | BW 283 | 9.8 × 10\hat{ }7 | BW 283 | 6.7 × 10\hat{ }7 |
| 0 | BW 281 | 3.1 × 10\hat{ }7 | BW 281 | 4.5 × 10\hat{ }7 |
| 0 | BW 276 | 5.3 × 10\hat{ }7 | BW 276 | 6.6 × 10\hat{ }7 |
| 0 | BW 14 | 1.5 × 10\hat{ }7 | BW 14 | 3.3 × 10\hat{ }7 |
| 0 | BW 13 | 2.6 × 10\hat{ }7 | BW 12 | 3.6 × 10\hat{ }7 |
| 8 | BW 283 | 8.2 × 10\hat{ }6 | BW 283 | 3.4 × 10\hat{ }7 |
| 8 | BW 281 | 4.0 × 10\hat{ }7 | BW 281 | 5.0 × 10\hat{ }7 |
| 8 | BW 276 | 7.9 × 10\hat{ }6 | BW 276 | 3.1 × 10\hat{ }7 |
| 8 | BW 14 | 2.2 × 10\hat{ }7 | BW 14 | 2.8 × 10\hat{ }7 |
| 8 | BW 13 | 2.6 × 10\hat{ }7 | BW 12 | 4.5 × 10\hat{ }7 |
| 19 | BW 283 | 8.8 × 10\hat{ }7 | BW 283 | 9.1 × 10\hat{ }7 |
| 19 | BW 281 | 2.7 × 10\hat{ }7 | BW 281 | 3.3 × 10\hat{ }7 |
| 19 | BW 276 | 2.1 × 10\hat{ }7 | BW 276 | 2.9 × 10\hat{ }7 |
| 19 | BW 14 | 1.8 × 10\hat{ }7 | BW 14 | 1.9 × 10\hat{ }7 |
| 19 | BW 13 | 2.2 × 10\hat{ }7 | BW 12 | 4.4 × 10\hat{ }7 |
| 29 | BW 283 | 9.3 × 10\hat{ }7 | BW 283 | 8.9 × 10\hat{ }7 |
| 29 | BW 281 | 2.4 × 10\hat{ }7 | BW 281 | 5.2 × 10\hat{ }7 |
| 29 | BW 276 | 1.1 × 10\hat{ }8 | BW 276 | 3.2 × 10\hat{ }7 |
| 29 | BW 14 | 2.2 × 10\hat{ }7 | BW 14 | 5.5 × 10\hat{ }7 |
| 29 | BW 13 | 2.2 × 10\hat{ }7 | BW 12 | 5.8 × 10\hat{ }7 |

Disease assessments were performed weekly for 84 total days and the AUDPC for each plant was calculated (Tables 18 and 19).

TABLE 18
Mean Area Under Disease Progress Curve of each bacterial antagonist and treatment combination for the
Macrophomina phaseolina trial.

| Treatment | Timing | Day 107 | AUDPC |
|---|---|---|---|
| Serenade ASO | 1. Root Dip on Day 0, Drench on Day 10 | 62.5 | 4893.8 |
| Serenade ASO | 2. Drench on Day 0, Drench on Day 10 | 91.7 | 2712.5 |
| Serenade ASO | 3. Root Dip on Day 0, Drench on Day 10, Drench on Day 20 | 79.2 | 4597.9 |
| Serenade ASO | 4. Root Dip on Day 0, Drench on Day 10, Drench on Day 20, Drench on Day 30 | 54.2 | 3893.8 |
| DoubleNickel LC | 1. Root Dip on Day 0, Drench on Day 10 | 54.2 | 2143.8 |
| DoubleNickel LC | 2. Drench on Day 0, Drench on Day 10 | 58.3 | 2975.0 |
| DoubleNickel LC | 3. Root Dip on Day 0, Drench on Day 10, Drench on Day 20 | 45.8 | 2239.6 |
| DoubleNickel LC | 4. Root Dip on Day 0, Drench on Day 10, Drench on Day 20, Drench on Day 30 | 66.7 | 2625.0 |
| BW 283 | 1. Root Dip on Day 0, Drench on Day 10 | 58.3 | 3529.2 |
| BW 283 | 2. Drench on Day 0, Drench on Day 10 | 62.5 | 2289.6 |
| BW 283 | 3. Root Dip on Day 0, Drench on Day 10, Drench on Day 20 | 50.0 | 1866.7 |
| BW 283 | 4. Root Dip on Day 0, Drench on Day 10, Drench on Day 20, Drench on Day 30 | 58.3 | 2216.7 |
| BW 281 | 1. Root Dip on Day 0, Drench on Day 10 | 75.0 | 3529.2 |
| BW 281 | 2. Drench on Day 0, Drench on Day 10 | 66.7 | 3791.7 |
| BW 281 | 3. Root Dip on Day 0, Drench on Day 10, Drench on Day 20 | 70.0 | 2415.0 |
| BW 281 | 4. Root Dip on Day 0, Drench on Day 10, Drench on Day 20, Drench on Day 30 | 70.8 | 2872.9 |
| BW 14 | 1. Root Dip on Day 0, Drench on Day 10 | 54.2 | 1618.8 |
| BW 14 | 2. Drench on Day 0, Drench on Day 10 | 58.3 | 3208.3 |
| BW 14 | 3. Root Dip on Day 0, Drench on Day 10, Drench on Day 20 | 87.3 | 1881.3 |
| BW 14 | 4. Root Dip on Day 0, Drench on Day 10, Drench on Day 20, Drench on Day 30 | 45.8 | 2085.4 |
| BW 13 | 1. Root Dip on Day 0, Drench on Day 10 | 79.2 | 2085.4 |
| BW 13 | 2. Drench on Day 0, Drench on Day 10 | 70.8 | 3572.9 |
| BW 13 | 3. Root Dip on Day 0, Drench on Day 10, Drench on Day 20 | 66.7 | 4229.2 |
| BW 13 | 4. Root Dip on Day 0, Drench on Day 10, Drench on Day 20, Drench on Day 30 | 75.0 | 3645.8 |
| BW 276 | 1. Root Dip on Day 0, Drench on Day 10 | 54.2 | 2435.4 |
| BW 276 | 2. Drench on Day 0, Drench on Day 10 | 70.8 | 3581.3 |
| BW 276 | 3. Root Dip on Day 0, Drench on Day 10, Drench on Day 20 | 58.3 | 1779.2 |
| BW 276 | 4. Root Dip on Day 0, Drench on Day 10, Drench on Day 20, Drench on Day 30 | 62.5 | 2260.4 |
| Inoculated Water Control | 1. Drench on Day 0, Drench on Day 10, Drench on Day 20, Drench on Day 30 | 75.0 | 3500.0 |
| Inoculated Water Control | 2. Root Dip on Day 0, Drench on Day 10, Drench on Day 20, Drench on Day 30 | 91.7 | 3441.7 |
| NON-Inoculated Water | 1. Drench on Day 0, Drench on Day 10, Drench on Day 20, Drench on Day 30 | 29.2 | 1210.4 |
| NON-Inoculated Water | 2. Root Dip on Day 0, Drench on Day 10, Drench on Day 20, Drench on Day 35 | 29.2 | 802.1 |

TABLE 19
Mean Area Under Disease Progress Curve of each bacterial antagonist and treatment combination for the
Verticillium dahliae trial.

| Treatment | Timing | Day 107 | AUDPC |
|---|---|---|---|
| Serenade ASO | 1. Root Dip on Day 0, Drench on Day 10 | 91.7 | 3558.3 |
| Serenade ASO | 2. Drench on Day 0, Drench on Day 10 | 95.8 | 3602.1 |
| Serenade ASO | 3. Root Dip on Day 0, Drench on Day 10, Drench on Day 20 | 95.8 | 3397.9 |
| Serenade ASO | 4. Root Dip on Day 0, Drench on Day 10, Drench on Day 20, Drench on Day 30 | 87.5 | 2989.6 |
| DoubleNickel LC | 1. Root Dip on Day 0, Drench on Day 10 | 95.8 | 3572.9 |
| DoubleNickel LC | 2. Drench on Day 0, Drench on Day 10 | 95.8 | 3485.4 |
| DoubleNickel LC | 3. Root Dip on Day 0, Drench on Day 10, Drench on Day 20 | 95.8 | 3339.6 |
| DoubleNickel LC | 4. Root Dip on Day 0, Drench on Day 10, Drench on Day 20, Drench on Day 30 | 87.5 | 2931.3 |
| BW 283 | 1. Root Dip on Day 0, Drench on Day 10 | 95.8 | 3514.6 |
| BW 283 | 2. Drench on Day 0, Drench on Day 10 | 100.0 | 3470.8 |
| BW 283 | 3. Root Dip on Day 0, Drench on Day 10, Drench on Day 20 | 95.8 | 3397.9 |
| BW 283 | 4. Root Dip on Day 0, Drench on Day 10, Drench on Day 20, Drench on Day 30 | 95.8 | 3310.4 |
| BW 281 | 1. Root Dip on Day 0, Drench on Day 10 | 100.0 | 3587.5 |
| BW 281 | 2. Drench on Day 0, Drench on Day 10 | 100.0 | 3412.5 |
| BW 281 | 3. Root Dip on Day 0, Drench on Day 10, Drench on Day 20 | 100.0 | 3500.0 |
| BW 281 | 4. Root Dip on Day 0, Drench on Day 10, Drench on Day 20, Drench on Day 30 | 95.8 | 3368.8 |
| BW 14 | 1. Root Dip on Day 0, Drench on Day 10 | 100.0 | 3441.7 |
| BW 14 | 2. Drench on Day 0, Drench on Day 10 | 100.0 | 3500.0 |
| BW 14 | 3. Root Dip on Day 0, Drench on Day 10, Drench on Day 20 | 95.8 | 3456.3 |
| BW 14 | 4. Root Dip on Day 0, Drench on Day 10, Drench on Day 20, Drench on Day 30 | 91.7 | 3120.8 |
| BW 12 | 1. Root Dip on Day 0, Drench on Day 10 | 100.0 | 3412.5 |
| BW 12 | 2. Drench on Day 0, Drench on Day 10 | 95.8 | 3485.4 |
| BW 12 | 3. Root Dip on Day 0, Drench on Day 10, Drench on Day 20 | 95.8 | 2872.9 |
| BW 12 | 4. Root Dip on Day 0, Drench on Day 10, Drench on Day 20, Drench on Day 30 | 87.5 | 2989.6 |
| BW 276 | 1. Root Dip on Day 0, Drench on Day 10 | 100.0 | 3587.5 |
| BW 276 | 2. Drench on Day 0, Drench on Day 10 | 95.8 | 3602.1 |
| BW 276 | 3. Root Dip on Day 0, Drench on Day 10, Drench on Day 20 | 100.0 | 3616.7 |
| BW 276 | 4. Root Dip on Day 0, Drench on Day 10, Drench on Day 20, Drench on Day 30 | 100.0 | 3441.7 |
| Inoculated Water Control | 1. Drench on Day 0, Drench on Day 10, Drench on Day 20, Drench on Day 30 | 95.8 | 3660.4 |
| Inoculated Water Control | 2. Root Dip on Day 0, Drench on Day 10, Drench on Day 20, Drench on Day 30 | 91.7 | 3587.5 |
| NON-Inoculated Water | 1. Drench on Day 0, Drench on Day 10, Drench on Day 20, Drench on Day 30 | 12.5 | 247.9 |
| NON-Inoculated Water | 2. Root Dip on Day 0, Drench on Day 10, Drench on Day 20, Drench on Day 35 | 12.5 | 247.9 |

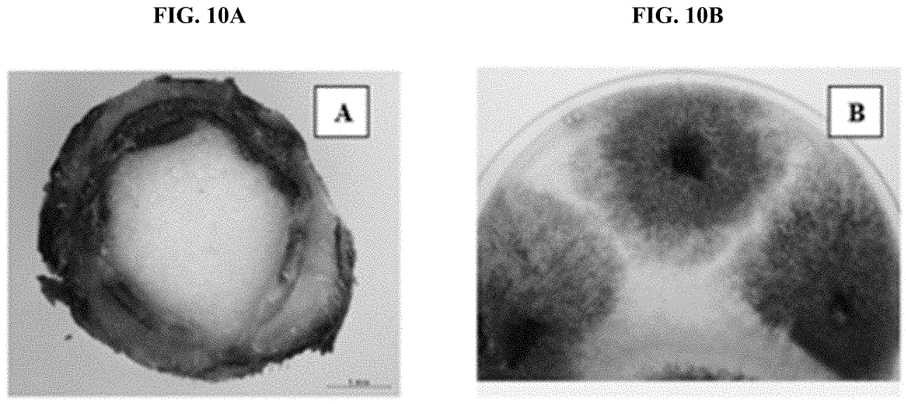

M. phaseolina and V. dahliae were successfully isolated from symptomatic crown tissue most of the time, ranging from 58% to 87% for Macrophomina and 80 to 92% for Verticillium (FIG. 10A and FIG. 10B).

### Example 6. Pineapple Black Rot In Vivo Study

Pineapple Black Rot (Chalara paradoxa, Ceratocystic paradox, or Theilaviopsis paradoxa) is a major problem in the pineapple industry. Infection can occur in the field or during the post-harvest process. Infection occurs through wound sites on the fruit and destroys the soft tissue of the fruit.

BiOWiSH® biocontrol product Guard'n Fresh (B. subtilis, B. licheniformis, B. pumilus, and B. subtilis KLB at a ratio of 3:1:3:1.3 by CFU) and a BiOWiSH® prototype (Bacillus subtilis 34 KLB and Bacillus amyloliquefaciens at a ratio of about 1:1 by CFU) were evaluated for their potential to reduce black rot of pineapple caused by the fungus Chalara paradoxa. Pineapple fruits were supplied by Dole. Chalara pardoxa was isolated from banana and cultured on 10% V8 juice agar. The pineapple fruits were intentionally wounded to provide entry site for the pathogen. Immediately after inoculation with the pathogen the fruits were treated with the BiOWiSH® treatment then stored in plastic bags at high humidity overnight. This was followed by 10 days storage at room temperature. The fruits were evaluated for infection after the 10-day storage period. The experimental design is shown in Table 20.

TABLE 20

| | | BiOWiSH ™ | |
|---|---|---|---|
| | | GUARD'n | BiOWiSH ® |
| | | FRESH | Prototype 1, 1 |
| | No Treatment | 2 mL/gallon | gram/gallon |
| No inoculation | Cell 1 - Negative | Cell 4* | Cell 7* |
| | Control* | | |
| Inoculation with | Cell 2 - Positive | Cell 5 | Cell 8 |
| 1 × 10³/mL | Control | | |
| Inoculation with | Cell 3 - Positive | Cell 6 | Cell 9 |
| 1 × 10⁶/mL | Control | | |

There were 2 fruits per treatment for the fungal inoculated legs and 3 fruits per treatment for the no fungal inoculation legs, for a total of 21 fruits.

After the 10-day room temperature storage period the fruits were sectioned longitudinally and the percentage of fruit area diseased calculated via image analysis.

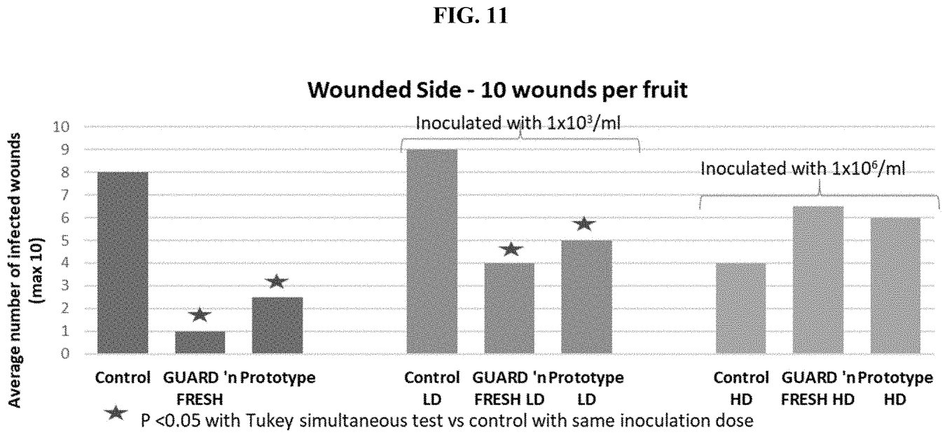

Pineapple treated with BiOWiSH® products showed significantly fewer incidents of Black Rot, both in the uninoculated and low-dose inoculated legs (FIG. 11).

The presence of Black Rot in uninoculated fruit (FIG. 11) shows that the fruit were already infected when purchased. Treatment of these fruit with BiOWiSH® showed a significant reduction in Black Rot relative to the control. There was no difference significant difference between BiOWiSH® products.

Both BiOWiSH® products gave a significant reduction in Black Rot at low (1×10³ CFU/mL) C. paradoxa inoculation. At the higher inoculation level (1×10⁶ CFU/mL) the BiOWiSH® showed no efficacy in controlling Black Rot infection.

This test demonstrates the potential for BiOWiSH® biocontrol products to control Black Rot. More repetitions are needed in order to confirm these initial findings.

### Example 7. Mango Anthracnose Field Trial

Evaluate the potential for sprays of BiOWiSH® Guard'n Shield (B. subtilis, B. licheniformis, B. pumilus, and B. subtilis KLB at a ratio of 3:1:3:1.3 by CFU) and BiOWiSH® Prototype (Bacillus subtilis 34 KLB and Bacillus amyloliquefaciens at a ratio of about 1:1 by CFU).

Several varieties of mango were tested including Maha janok, Repoza, Gloden Glow, Peach 1, Roberto 2, r2e2, Kensington pride, Paris and Keitt. Field testing was conducted in two locations where the pathogen had previously been shown to be naturally occurring. Beginning at flowering, mango panicles were sprayed weekly with:
Treatment 1: BiOWiSH® Guard'n Shield at 2 mL/gallon using a backpack sprayer (5-10 panicles per tree)
Treatment 2: BiOWiSH® prototype at 1 gram/gallon using a backpack sprayer. (5-10 panicles per tree).
Treatment 3: Control—water only (5-10 panicles per tree).

Each of 5-8 trees per test location were divided equally into thirds, one for each treatment, using surveyors' tape and each tree received all three treatments. Each panicle was tagged with flagging tape and identified numerically. Each treatment was repeated weekly until fruits reached full size.

TABLE 21

| Treatment | N | Mean | Grouping |
|---|---|---|---|
| Control | 34 | 20.25 | A |
| Prototype | 22 | 2.77 | B |
| Guard'n Shield | 13 | 1.50 | B |

Means that do not share a letter are significantly different

Both BiOWiSH® biocontrol products controlled anthracnose of mango significantly better than the control.

### EQUIVALENTS

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

1. An antifungal composition comprising a bacterial mixture, wherein the bacterial mixture consists essentially of Bacillus subtilis 34 KLB and Bacillus amyloliquefaciens at a ratio of about 10:1 to 1:10 by colony-forming unit (CFU), and wherein the antifungal composition can inhibit the growth of Ganoderma lucidum at least 10% more than either Bacillus subtilis 34 KLB or Bacillus amyloliquefaciens alone with the same CFU as the antifungal composition.

2. The antifungal composition of claim 1, wherein the bacterial mixture is a powder.

3. The antifungal composition of claim 2, wherein each bacteria in the bacterial mixture is individually fermented, harvested, dried, and ground to produce a powder having a mean particle size of about 200 microns, with greater than 60% of the mixture in the size range between 100-800 microns.

4. The antifungal composition of claim 1, wherein the bacterial mixture is a liquid.

5. The antifungal composition of claim 1, having a bacterial concentration of 10⁹ to 10¹¹ CFU/g.

6. The antifungal composition of claim 1, further comprising a water-soluble diluent.

7. The antifungal composition of claim 6, wherein the water-soluble diluent is selected from the group consisting of dextrose, maltodextrin, sucrose, sodium succinate, potassium succinate, fructose, mannose, lactose, maltose, dextrin, sorbitol, xylitol, inulin, trehalose, starch, cellobiose, carboxy methyl cellulose, dendritic salt, sodium sulfate, potassium sulfate, and a combination thereof.

8. The antifungal composition of claim 1, wherein the bacterial mixture consists of Bacillus subtilis 34 KLB and Bacillus amyloliquefaciens.

9. A method of treating or preventing Black Sigatoka in a banana plant, the method comprising contacting the banana plant with the antifungal composition of claim 1.

10. The method of claim 9, wherein the banana plant is contacted with the antifungal composition monthly throughout the fruit growth cycle.

11. The method of claim 9, wherein the method reduces the disease severity by at least 10% as compared to a control plant absent any treatment.

12. A method of treating or preventing Fusarium wilt in a plant, the method comprising contacting the plant with the antifungal composition of claim 1.

13. The method of claim 12, wherein the plant is contacted with the antifungal composition monthly.

14. The method of claim 12, wherein the method reduces the disease severity by at least 10% as compared to a control plant absent any treatment.

15. The method of claim 12, wherein the plant is selected from the group consisting of tomato, tobacco, legumes, cucurbits, sweet potatoes, mangos, Papayas, pineapple, coffee, spinach, and banana.

16. A method of treating or preventing a disease in a plant selected from: anthracnose;
ghost spot;
a leaf spot disease;
crown rot;
stem blight;
citrus mold;
leaf blight;
fruit rot;
brown rot;
black rot;
gray mold;
black mold;
cigar-end rot;
blight caused by Xanthomonas axonopodis pv. dieffenachiae;
decay caused by an Acidovorax species, an Enterobacter species, or a combination thereof;
Cercospora leaf spot;
branch canker and dieback;
Verticillium wilt caused by a Verticillium species; and
pineapple rot,
the method comprising contacting the plant with the antifungal composition of claim 1.

17. (canceled)

18. The method of claim 16, wherein the plant is contacted with the antifungal composition monthly.

19. The method of claim 16, wherein the method reduces the disease severity by at least 10% as compared to a control plant absent any treatment.

20. The method of claim 16, wherein the plant is selected from the group consisting of tomato, mango, Aloe, turfgrass, ash, birch, walnut, buckeye, elm, hornbeam, maple, oak, sycamore, Catalpa, dogwood, hickory, linden, taro, Papaya, wheat, an apple tree, a cherry tree, a peach tree, banana, strawberry, pineapple, fig, peach, grapes, orange, grapefruit, lime, almond, cherry, plum, apricot, potatoes, peppers, a fruit tree, an ornamental plant, an apricot tree, a plum tree, a nectarine tree, cyclamen, poinsettia, Primula, impatiens, Begonia, Nicotiana geranium, sweet peas, grape plant, artichoke, asparagus, bean, beet, blackberry, black-eyed pea, banana plant, Liberian coffee tree, an avocado tree, cocoa tree, beach morning glory, watermelon, milo, and poplar.

21-105. (canceled)
